(19) United States
(12) Patent Application Publication
(10) Pub. No.: US 2017/0337356 A1
(43) Pub. Date: Nov. 23, 2017

(54) METHOD AND APPARATUS FOR MANAGING CONTENT IN STORAGE-BASED SECURITY SYSTEM

(71) Applicant: LG ELECTRONICS INC., Seoul (KR)

(72) Inventors: Sunghyun CHO, Seoul (KR); Gyoyoon LEE, Seoul (KR); Ahyoung SHIN, Seoul (KR)

(73) Assignee: LG ELECTRONICS INC., Seoul (KR)

(21) Appl. No.: 15/522,747

(22) PCT Filed: Oct. 27, 2015
(86) PCT No.: PCT/KR2015/011381

§ 371 Date: Apr. 27, 2017

Related U.S. Application Data
(60) Provisional application No. 62/069,282, filed on Oct. 27, 2014.
(60) Provisional application No. 62/069,286, filed on Oct. 27, 2014.

(51) Int. Cl. G06F 21/10; G06F 21/60; G06F 21/12; G06Q 30/06

(52) U.S. Cl. CPC G06F 21/105; G06Q 30/0601; G06F 21/602; G06Q 30/0645; G06F 21/121; G06F 2221/0773; G06Q 2220/18

(57) ABSTRACT

The present invention provides a method for reproducing a content stored in a storage device connected through at least one interface, the method comprising the steps of: transmitting transaction information stored in a detected storage device to a license server, wherein the transaction information includes a transaction identification file which identifies at least one of a corresponding transaction, a seller, and a user; receiving, from the license server, license information which grants permission to reproduce the content; and reproducing the content on the basis of the license information, wherein the license information includes a license file and a license key.

### TECHNICAL FIELD

The present invention relates to a method and an apparatus for managing content in a storage-based security system. More specifically, the present invention relates to a method for loaning or returning content within a storage medium and a method for migrating a content library of a storage device; and an apparatus for the method.

### BACKGROUND ART

As smartphones and smart TVs are now adopting UHD (Ultra High Definition) technology beyond Full HD (High Definition) resolution, the world is expected to experience a variety of secure high quality and ultra-high quality content (in what follows, it is called ‘secure high quality content’) in various fields including movie, concert, and sports as well as public broadcasting.

However, if it is the case that existing playback devices are incapable of play secure high quality content, there is no other way for the users to enjoy such content. Therefore, any new playback device should be able to play secure high quality content, and existing playback devices should have a means to play the secure high quality content. A user needs a proper right to play secure high quality content, and the user may need a method for managing secure high quality content for more efficient management thereof. Also, a method for copy prevention may be needed for proper distribution and consumption of secure high quality content, and a method for managing license information may also be needed for playback of secure high quality content.

Also, a method for copying or moving secure high quality content to a different storage or a different playback device for various application thereof is required; furthermore, a method for loaning or returning the secure high quality content may be needed.

Moreover, in case the user has to replace a storage device due to upgrade or occurrence of a failure of the storage device from a system playing or managing secure high quality content, a method for performing library migration may be needed.

### DISCLOSURE

### Technical Problem

The present invention attempts to provide a method for enabling existing playback devices to play secure high quality content.

Also, the present invention attempts to provide a method for managing secure high quality content in an efficient manner.

Also, the present invention attempts to provide a method for copy prevention for proper distribution and consumption of secure high quality content and a method for managing license information required for playing the secure high quality content.

Also, the present invention attempts to provide a method for loaning or returning secure high quality content as well as a method for copying or moving the secure high quality content to a different storage or a different playback device for various applications of the secure high quality content.

Also, the present invention attempts to provide a method for performing library migration for playing or managing secure high quality content in a more efficient manner.

### Technical Solution

The present invention provides a system architecture supporting a device structure, network structure, and transport protocol between a server and a device capable of playing secure high quality content.

Also, the present invention provides a method for obtaining license information for playing secure high quality content.

Also, the present invention provides a method for defining a session for transmitting information among devices in a system playing secure high quality content.

Also, the present invention provides a method for copying or moving secure high quality content to a different storage or a different playback device.

Also, the present invention provides a method for loaning or returning secure high quality content.

Also, the present invention provides a method for performing library migration of secure high quality content.

### Advantageous Effects

Even if a user device is connected to a storage device storing content of a format or profile not supported by the user device, the user may play high quality or ultra-high quality content by automatically searching for and/or downloading a substitute of the content file that may be played in the user device through the Internet.

Therefore, in case the user device is unable to play the content stored in a storage device, the user doesn't have to go through a tedious procedure of searching for the content by directly accessing a download server or selecting and downloading the searched content.

Also, since the present invention allows a playback device even with poor performance to search for and play substitutable content, the user may receive a variety of content services.

Also, since the present invention supports a directory structure and a file format for high quality content, secure high quality content may be managed and played in a more efficient manner.

Also, since license information of high quality content is obtained from a license server, the user may add an additional function to an existing certified device without going through a separate certification and enjoy high quality content by associating the content with the additional function.

Also, since a playback device checks playback right periodically, an enhanced license management function may be applied for playing high quality content.

### BRIEF DESCRIPTION OF THE DRAWINGS

FIG. 1 illustrates a system for using a secure high definition content service according to an embodiment of the present invention.

FIG. 2 illustrates an internal block diagram of a playback device for playing secure HD content according to an embodiment of the present invention.

FIG. 3 illustrates an internal block diagram of a storage device capable of storing secure HD content according to an embodiment of the present invention.

FIG. 4 is a flow diagram illustrating a process of automatically turning on power of a second playback device in case a storage device is inserted into a first playback device according to an embodiment of the present invention.

FIG. 5 illustrates a network system structure obtaining license information for playing secure HD content stored in a storage device according to an embodiment of the present invention.

FIG. 6 is a flow diagram illustrating a process of licensed copy and unlicensed copy of secure HD content between storage devices according to an embodiment of the present invention.

FIG. 7 is a flow diagram illustrating a process of licensed move and unlicensed move of secure HD content between storage devices according to an embodiment of the present invention.

FIG. 8 is a flow diagram illustrating a process of obtaining license information for playing secure HD content stored in a storage device according to an embodiment of the present invention.

FIG. 9 is a flow diagram illustrating a process of providing content through a session established between devices according to an embodiment of the present invention.

FIG. 10 is a flow diagram illustrating a process of providing license information through a session established between devices according to an embodiment of the present invention.

FIG. 11 illustrates internal functional block diagrams of a playback device and an certification device for managing content playback right according to an embodiment of the present invention.

FIG. 12 illustrates a data structure defining a rights field for loan or return of content within a transaction identification file(Transaction Handle) according to an embodiment of the present invention.

FIG. 13 illustrates a data structure defining a rights field for loan or return of content within a license file, period field, encryption key field, and version field according to an embodiment of the present invention.

FIG. 14 is a block diagram illustrating a process of loaning secure HD content from the viewpoint of a source storage device according to an embodiment of the present invention.

FIG. 15 illustrates a structure of a transaction identification file(Transaction Handle) used when loaning of secure HD content is performed according to an embodiment of the present invention.

FIG. 16 illustrates a structure of a license file before and after loan of secure HD content according to an embodiment of the present invention.

FIG. 17 is a block diagram illustrating a process of loaning secure HD content from the viewpoint of a loan storage device according to an embodiment of the present invention.

FIG. 18 is a block diagram illustrating a content return process of a source storage device and a loan storage device according to an embodiment of the present invention.

FIG. 19 illustrates a process of checking version information in case multiple loans are allowed according to an embodiment of the present invention.

FIG. 20 illustrates a process of performing loan of secure HD content for each profile according to an embodiment of the present invention.

FIG. 21 is a flow diagram illustrating a process of loaning a license of secure HD content with respect to a source storage according to an embodiment of the present invention.

FIG. 22 is a block diagram illustrating a process of loaning a license of secure HD content with respect to a loan storage according to an embodiment of the present invention.

FIG. 23 is a flow diagram illustrating a process of playing secure HD content through accessing a license server with respect to a loan storage according to an embodiment of the present invention.

FIG. 24 is a flow diagram illustrating a process of playing secure HD content without accessing a license server with respect to a loan storage according to an embodiment of the present invention.

FIG. 25 is a flow diagram illustrating a process of terminating loan of secure HD content with respect to a source storage according to an embodiment of the present invention.

FIG. 26 is a flow diagram illustrating a process of performing an early return with respect to a loan storage according to an embodiment of the present invention.

FIG. 27 is a block diagram illustrating a process of content loan and return with respect to a source storage and a loan storage according to another embodiment of the present invention.

FIG. 28 is a flow diagram illustrating a process of delivering a transaction identification file to a license server according to an embodiment of the present invention.

FIG. 29 is a block diagram illustrating a method for performing content library migration in case secure HD content is copied or moved according to an embodiment of the present invention.

FIG. 30 illustrates a structure of a transaction identification file(Transaction Handle) used when content library migration is performed according to an embodiment of the present invention.

FIG. 31 is a block diagram illustrating a method for performing content library migration when a storage device is lost according to an embodiment of the present invention.

FIG. 32 is a table illustrating error codes defined when content library migration is performed according to an embodiment of the present invention.

FIG. 33 is a flow diagram illustrating a method for performing content library migration on secure HD content according to an embodiment of the present invention.

### BEST MODE

The present invention provides a method for playing content stored in a storage device connected through at least one interface, the method comprising transmitting transaction information stored in a detected storage device to a license server, wherein the transaction information includes a transaction identification file for identifying at least one of corresponding transaction, seller, and user; receiving license information allowing playback of the content from the license server; and playing the content on the basis of the license information, wherein the license information includes a license file and a license key.

Also, the present invention further comprises requesting loan permission of the content from a license server; and receiving a response with respect to the request from the license server.

Also, according to the present invention, at least one of the transaction identification file or the license file includes a right information field indicating license type, and the license type is used for checking whether the license for the content is the original license or a loan license.

Also, according to the present invention, the transaction identification file further comprises loan version information.

Also, according to the present invention the license file includes at least one of content loan time information, content return time information, encryption key for loan or return, and loan version information.

Also, when the user performs migration of the content to another storage device, the method according to the present invention further comprises: checking through the license server whether the user has a right for migration of the content; and migrating the content to the another storage device when there exists a right for migration of the content according to the checking result.

Also, according to the present invention, the transaction identification file includes a migration count field, and the migration count field represents the number of migrations performed.

Also, according to the present invention, when the content is migrated to the another storage device, a value of the migration count field is increased by one.

Also, the method according to the present invention further comprises: comparing storage capacity of the another storage device with storage capacity of the storage device, and performing migration is performed excluding overlapped content when storage capacity of the another storage device is smaller.

Also, the method according to the present invention further comprises receiving migration error information when the content is migrated, wherein the error information includes at least one of a transaction identification file error, license error, content file error, consecutive file error, secret key value error, title error, or certificate list error.

Also, a device for playing content stored in a storage device connected through at least one interface according to the present invention comprises an interface unit detecting connection of the storage device; a controller configured to transmit transaction information stored in the detected storage device to a license server, receive license information allowing playback of the content from the license server, and play the content on the basis of the license information; and a display unit configured to display the played content, wherein the transaction information includes a transaction identification file for identifying at least one of corresponding transaction, seller, and user, and wherein the license information includes a license file and a license key.

Also, according to the present invention, the controller is configured to request loan permission of the content from a license server and to receive a response with respect to the request from the license server.

Also, according to the present invention, when the user performs migration of the content to a another storage device, the controller is configured to check through the license server whether there exists a right for migration of the content; and to migrate the content to the another storage device when there exists a right for migration of the content according to the checking result.

Also, according to the present invention, the controller is configured to compare storage capacity of the another storage device with storage capacity of the storage device, and to perform migration excluding overlapped content when storage capacity of the another storage device is smaller.

Also, according to the present invention, the controller is configured to receive migration error information when the content is migrated, wherein the error information includes at least one of a transaction identification file error, license error, content file error, consecutive file error, secret key value error, title error, or certificate list error.

### MODE FOR INVENTION

Hereinafter, elements and actions of embodiments of the present invention will be described below in more detail with reference to the accompanying drawings. However, the elements and actions illustrated in the drawings and described with reference thereto are set forth only as examples and do not limit the spirit of the invention or its key elements and actions.

The terms used in this specification were selected to include current, widely-used, general terms. However, in certain cases, a term may be one that was arbitrarily established by the applicant. In such cases, the meaning of the term will be defined in the relevant portion of the detailed description. As such, the terms used in the specification are not to be defined simply by the name of the terms but are to be defined based on the meanings of the terms as well as the overall description of the present invention.

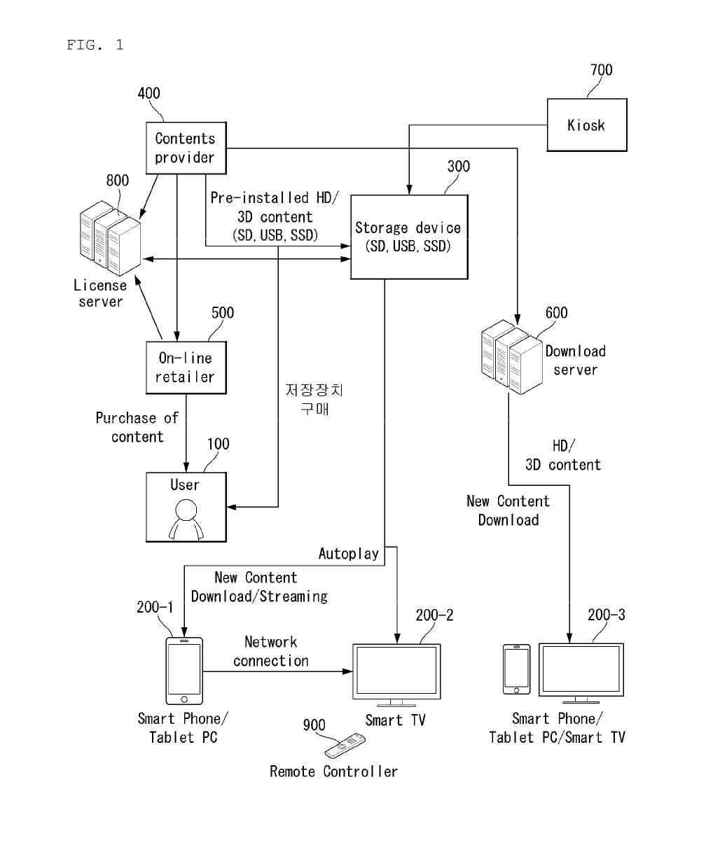

FIG. 1 illustrates a system for using a secure HD content service according to an embodiment of the present invention.

A system to which the present invention is applied may include a user 100 who purchases secure high definition content and uses the same, playback devices 200-1, 200-2, and 200-3 capable of playing the content, a storage device 300 in which the content has been stored or in which the content may be stored, a content provider 400 providing the content, a retailer 500 and an electronic kiosk 700 receiving the content and providing the received content to the user, and a download server 600 storing the content to allow the content to be downloaded, and a license server 800 providing license information allowing the content to be played. Also, the system may further include an external interface 900, for example, a remote controller, for controlling an operation of the playback devices.

In an embodiment to which the present invention is applied, the user who wants to use a secure high definition (HD) content service may use the service through various methods. The secure HD content may include, for example, secure content storage association (SCSA) content, and content mentioned in this disclosure may include the SCSA content.

In a first example, the user 100 may use the service by purchasing a storage device in which the secure high definition content has already been stored. For example, the content provider 400 may preload content, which is intended to be provided, to a portable hard drive such as a hard disk drive (HDD) or a solid state drive (SSD) or a flash memory product such as a universal serial bus (USB) flash drive or a secure digital (SD) card, and purchase the same, and the user may use the service by purchasing the storage device storing desired content.

In a second example, the user 100 may use the service by purchasing content from a retailer 500 providing the secure high definition content service. For example, the retailer 500 may receive content from the content provider 400 and provide the content service online or offline, and the user 100 may use the service by properly purchasing content from the retailer 500. Also, the user 100 may also use the service by purchasing the storage device from the retailer 500.

In this case, the retailer 500 may provide transaction information corresponding to content purchase to the user 100. Here, the transaction information is information regarding content transaction activity, which may refer to aggregation information of right information. For example, the right information may represent the state in which a license may be issued to a storage device. And the transaction information may include transaction handle information for identifying at least one of the corresponding transaction, seller, and user; and right information representing a right information item of the corresponding content. At this time, the transaction handle information may provide a unique link to the corresponding transaction.

In a third example, the user 100 may play the content by inserting the storage device 300 storing secure high definition content into the playback device 200-1. For example, the playback device 200-1 may be any device which may be able to play multimedia content, such as a mobile device, a TV, a computer, a notebook computer, and a tablet PC.

In a fourth example, the user 100 may insert the storage device 300 in which the secure high definition content has been stored or may be stored into the first playback device 200-1, and play the content in the second playback device 200-2. Here, the first playback device 200-1 and the second playback device 200-2 may be connected by a network, and when the storage device 300 is inserted into the first playback device 200-1, power of the second playback device 200-2 may be automatically turned on. Also, content may be played in the second playback device 200-2 through an external interface (for example, the remote controller 800, or the like) or a user interface (for example, a touch screen, a voice, a gesture, and the like).

In a fifth example, the user 100 may insert the storage device 300 capable of storing secure high definition content into the playback device 200-3 and download the content from an external content server to thus play the content. Here, the content may be stored in the storage device 300, and the external content server may be a content server of the content provider 400 or the retailer 500.

In order to play the secure high definition content, a specific application may be required. The specific application mentioned in this disclosure may refer to a software program for playing secure high definition content. For example, the specific application may refer to a software program capable of playing copy-prevented high definition content which has been stored or may be stored in a portable hard drive such as an HDD or SSD or in a flash memory product such as a USB flash drive or an SD card.

In particular, in the case of a playback device unable to reproduce the secure high definition content, installation of the specific application may be essential to play the content.

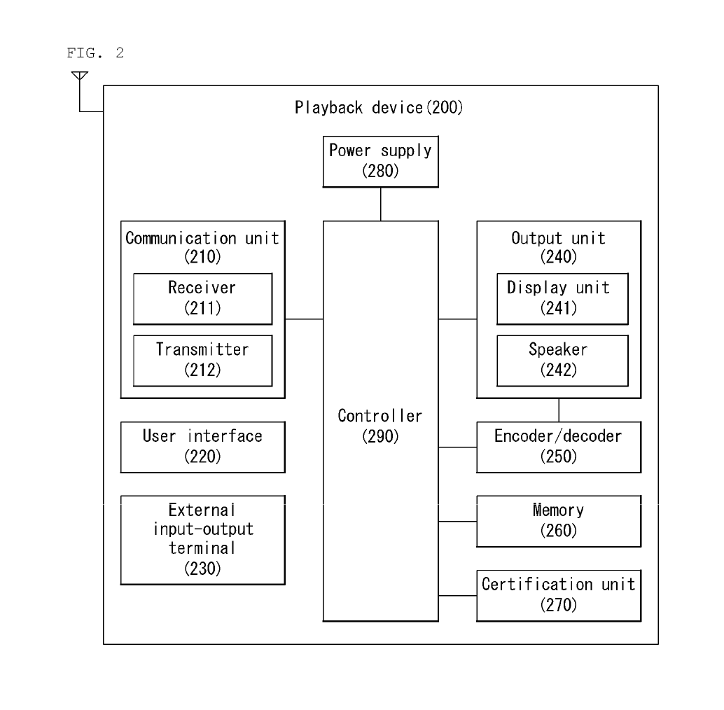

FIG. 2 illustrates an internal block diagram of a playback device for playing secure HD content according to an embodiment of the present invention.

The playback device 200 may include a communication unit 210, a user interface 220, an external input/output terminal 230, an output unit 240, an encoder/decoder 250, a memory 260, a certification unit 270, a power supply unit 280, and a control unit 290. The communication unit 210 may include a reception unit 211 and a transmission unit 212, and the output unit 240 may include a display unit 241 and a speaker 242.

The communication unit 210 may include one or more modules allowing for wired/wireless communication between the playback device 200 and the convent server or between the playback device 200 and other electronic device connected by a network. For example, the reception unit 211 may receive a signal transmitted from the content server or the other electronic device through a channel. Here, the signal may include secure high definition content data. The transmission unit 212 may transmit information required for downloading or streaming the secure high definition content data to the content server or the other electronic device. For example, the information required for downloading or streaming the secure high definition content data may include at least one among identification information, transaction information, license information, level information, and certificate information of the playback device and/or the storage device. Here, the license information may be information allowing purchased content to be played and may include at least one of license file information and license key information, for example.

The user interface 220 serves to transfer input information from the user to the playback device 200. For example, in order to control playing of the secure high definition content, in order to input information required for purchasing or certification procedure, or in order to perform setting for playing in other electronic device, the user interface 220 may be used. The user interface 220 may include a touch screen unit (not shown), a voice recognition unit (not shown), or a gesture recognition unit (not shown), and may be a separate external device such as a remote controller.

The external input/output terminal 230 may serve as a passage with an external device connected to the playback device 200. The external input/output terminal 230 may receive data or power from an external device and transfer the same to each component of the playback device 200, or transmit data within the playback device 200 to an external device. For example, the external input/output terminal 230 may be a connection terminal for connection with the storage device 300 and may include at least one among a USB port, a HDMI port, a wired/wireless headset port, an external charger port, a wired/wireless data port, a memory card port, an audio input/output (I/O) port, a video I/O port, and an earphone port. The storage device 300 and the playback device 200 may communicate through the external input/output terminal 230.

The output unit 240, serving to generate an output related to sight and hearing, may include the display unit 241 and the speaker 242.

The display unit 241 may output visual information processed in the playback device 200. For example, the display unit 241 may output secure high definition content, output information indicating that the storage device 300 has been plugged in, or output information required for a process of purchasing or certifying content. The display unit 241 may include at least one among a liquid crystal display (LCD), a thin film transistor liquid crystal display (TFT LCD), an organic light emitting diode (OLED), a flexible display, and a 3D display.

The speaker 242 may output acoustic information processed in the playback device 200. For example, the speaker 242 may output audio information of content or information required for playing the content, as voice information.

The encoder/decoder 250 may be used to perform decoding to display the secure high definition content or may be used to encode an image signal or an audio signal input from the playback device 200.

The memory 260 may store a program for operation of the control unit 290 or may temporarily store input/output data. For example, the memory 260 may store a specific application for playing the secure high definition content or may store identification information, profile information, level information, and certificate information of the playback device 200 and meta data of the content.

The memory 260 may include at least one type of storage mediums among a flash memory type, a hard disk type, a multimedia card micro-type, a card-type memory (e.g., an SD or XD memory, etc.), a random access memory (RAM), a static random access memory (SRAM), a read only memory (ROM), an electrically erasable programmable read only memory (EEPROM), a programmable read only memory (PROM), a magnetic memory, a magnetic disk, and an optical disk. Also, the playback device 200 may operate in relation to a Web storage performing a storage function of the memory 260 on the Internet.

The certification unit 270 may decrypt encrypted content to play the content. Here, the certification unit 270 may perform a response checking process regarding key information, and may transmit and receive right information of a storage device or a playback device.

The power supply unit 280 may receive external power and/or internal power and supply power required for operation of each component under the control of the control unit 290.

The control unit 290 controls a general operation of the playback device 200. For example, the control unit 290 may control an operation of detecting whether the storage device 300 is connected, receiving certificate information from the detected storage device, or transmitting the received certificate information to a server. Also, the control unit 290 may control an operation of receiving an encrypted media file and a certificate list (or a certificate revision list (CRL)) from the server on the basis of the certificate information, storing the encrypted media file to the storage device, update the certificate list, or playing the encrypted media file on the basis of the updated certificate list.

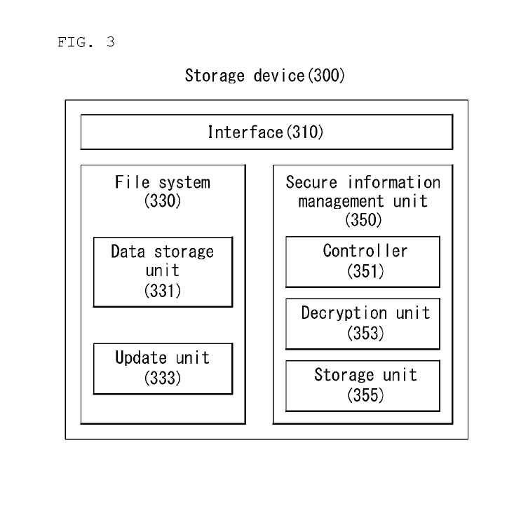

FIG. 3 illustrates an internal block diagram of a storage device capable of storing secure HD content according to an embodiment of the present invention.

The storage device 300 to which the present invention is applied may include an interface 310, a file system 330, and a secure information management unit 350. The file system 330 may include a data storage unit 331 and an updating unit 333, and the secure information management unit 350 may include a control unit 351, a decryption unit 353, and a storage unit 355.

The interface 310 serves as a passage with an external device connected to the storage device 300. For example, when the storage device 300 is plugged in to a playback device, the storage device 300 may receive data from the playback device or transmit internal data of the storage device 300 to the playback device through the interface 310.

The data storage unit 331 may store license information, password information, and the certificate revision list required for playing the encrypted multimedia content data.

The updating unit 333 may receive the certificate revision list and synchronize the received certificate list with previously stored certificate list, thus updating the certificate list. Here, the certificate revision list may be received from the playback device or an external server.

The secure information management unit 350 may be connected to a license server through the playback device, and may perform a handshake process with the license server regarding the license information, the password information, and the certificate list required for playing content. The control unit 351 of the secure information management unit 350 may control the forgoing process, and the decryption unit 353 may decrypt the license information or the password information. The storage unit 355 may store the license information and/or the password information, and the storage unit 355 may be a secure region within the storage device 300.

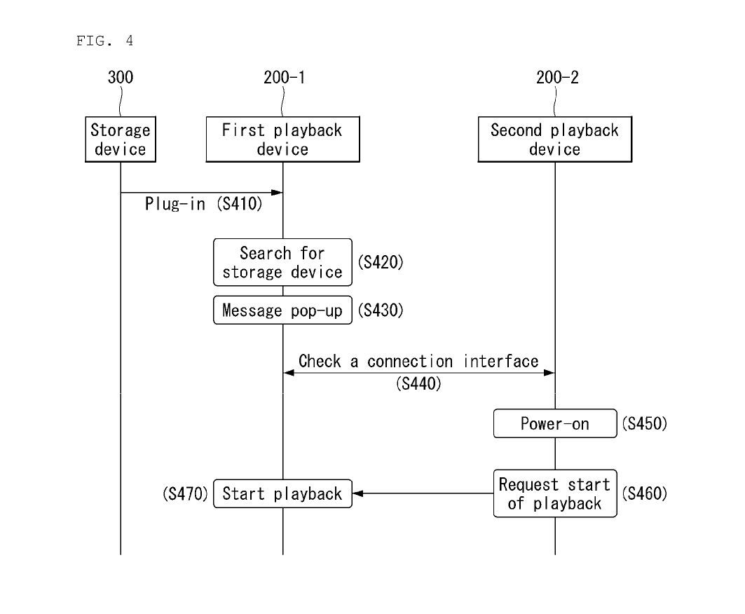

FIG. 4 is a flow diagram illustrating a process of automatically turning on power of a second playback device in case a storage device is inserted into a first playback device according to an embodiment of the present invention.

Referring to FIG. 4, if a storage device 300 storing secure HD content is plugged into a first playback device S410, the first playback device 200-1 may automatically search for a plugged-in storage device and identify the storage device 300 from the search result S420.

If the first playback device 200-1 confirms plug-in of the storage device 300, the first playback device 200-1 may display a message showing the plug-in of the storage device 300, which may be displayed in the form of a pop-up message S430. Also, the first playback device 200-1 may display a list of contents included in the storage device 300 and select the content to play through communication with an input device (media browsing).

Also, if the first playback device 200-1 confirms the plug-in of the storage device 300, the first playback device 200-1 may identify a different playback device connected to the first playback device 200-1 and check the connection interface to the different playback device S440. For example, the first playback device 200-1 can be a media player; the second playback device 200-2 may be a TV; and the first playback device 200-1 and the second playback device 200-2 may be connected to each other through a wired and a wireless interface such as HDMI (High Definition Multimedia Interface), Wake-on-LAN, and Bluetooth.

Meanwhile, if the first playback device 200-1 confirms the connection interface for the second playback device 200-2, the power of the second playback device 200-2 may be automatically turned on S450. And if the first playback device 200-1 requests playback of the corresponding content through the second playback device 200-2 S460, the first playback device 200-1 plays the content S470. At this time, the first playback device 200-1 may play the content according to the play start request from an external input device, and the content may be selected from the list of played contents.

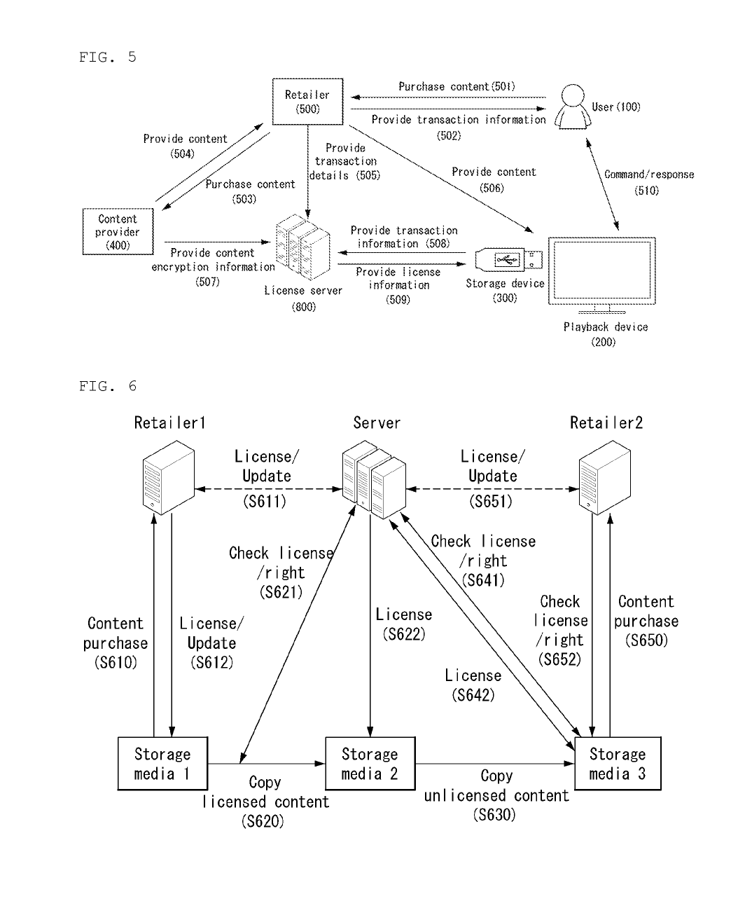

FIG. 5 illustrates a network system structure obtaining license information for playing secure HD content stored in a storage device according to an embodiment of the present invention.

In order for the user to purchase HD content and play it in a playback device, the user needs to obtain at least one of transaction information and license information corresponding to the HD content. Here, the transaction information refers to information regarding a content transaction activity, which may refer to aggregation information of right information. For example, the right information may refer to the information indicating the state in which a license may be issued to a storage device.

The transaction information may include transaction handle information for identifying at least one of the corresponding transaction, seller, and user; and right information representing a right information item of the corresponding content. At this time, the transaction handle information may provide a unique link for the corresponding transaction. And the license information refers to the information allowing purchased content to be played and may include at least one of a license file and a license key, for example.

In the present embodiment, a process of obtaining license information to play HD content will be described.

Referring to FIG. 5, the user 100 may purchase secure HD content from the retailer 500 (501). In the present embodiment, the retailer 500 is taken as an example, but content may also be purchased through any other route or other content retainer, for example, the content provider 400 or other user.

The retailer 500 may also request content purchase from the content provider 400 or another retailer 500 (503), and may be provided with content therefrom 504.

Upon receiving the purchase request from the user 100, the retailer 500 may provide the right to play HD content to the user through generation of transaction information. For example, the retailer 500 may provide transaction information to the user 100 (502), and provide transaction details to the license server 800 (505). Here, the provided transaction information may be stored in the storage device 300 and may correspond to one HD content. The HD content may be provided as content of a plurality of versions, and may be provided as one or more of SD, HD, UHD class content. Also, the retailer 500 may provide HD content to the storage device 300 (506).

The license server 800 may include an interface and data required for determining whether the storage device has the right to play content. The license server 800 may receive the transaction details from the retailer 500, receive content code information from the content provider 400 (507), and receive the transaction information from the storage device 300 (508).

The license server 800 may generate transaction information on the basis of the transaction details. Also, the transaction information may be generated by the retailer 500.

Meanwhile, the user 100 may request the playback device 200 to play the purchased HD content through an interface. Here, the transaction information stored in the storage device 300 may be transmitted to the license server 800, and the license server 800 may check whether there is right to play on the basis of the transaction information. When it is checked that there is right to play, the license server 800 may generate right information and license information and transmit the generated right information and license information to the storage device 300 (509). Here, the license information is information allowing the purchased content to be played, and may include at least one of license file information and license key information.

Upon receiving the right information and the license information, the storage device 300 may play the HD content.

FIG. 6 is a flow diagram illustrating a process of licensed copy and unlicensed copy of secure HD content between storage devices according to an embodiment of the present invention.

The secure HD content may be copied or moved from one storage device to another storage device. Here, the license server may provide the right for valid copying or movement.

First, when a storage media 1 purchases secure high definition content from a retailer 1 (S610), the retailer 1 may report contents of the content purchase to a server. Here, the server may refer to a license server. The server may provide a valid license regarding the content purchase to the retailer 1, and update a certificate list stored in the server (S611). Here, the certificate list may include at least one of a content title certificate list, a storage device certificate list, a playback device certificate list, and a license certificate list.

The retailer 1 may provide a valid license regarding the content purchase to the storage media 1, and update the certificate list stored in the retailer 1 (S612).

In another embodiment, in a case in which content properly purchased from the storage media 1 is intended to be copied to a storage media 2 (S620), the server may determine whether the storage media 2 has authority to play the content or whether the content may be copied (S621). When the storage media 2 has authority to play the content or the content may be copied according to the determination, copying of the content by the storage media 2 may be performed and the server may provide license information for playing the content to the storage media 2 (S622). Here, the storage media 2 may need to have capability of playing the content.

In another embodiment, when the content is intended to be copied invalidly (unlicensed copy) from the storage media 2 to a storage media 3 (S620), only a data file of the content may be copied from the storage media 2 to the storage media 3 and a certification procedure through the server is not performed (S630). However, when the storage media 3 intends to play the content, a new license may need to be issued.

In another embodiment, when the storage media 3 intends to play the content, the storage media 3 may request the right to play the content from the server (S641), and accordingly, the server may provide the right to play the content to the storage media 3 (S642).

However, when the right to play the content expires, the storage media 3 should newly purchase content from the retailer 2 (S650). When purchasing new content through the retailer 2 is completed, the retailer 2 may transmit the purchase information to the server and the server may update the certificate list stored in the server on the basis of the new purchase information (S651). The retailer 2 may provide a valid license regarding the content purchase to the storage media 3, and update a certificate list stored in the retailer 2 (S652).

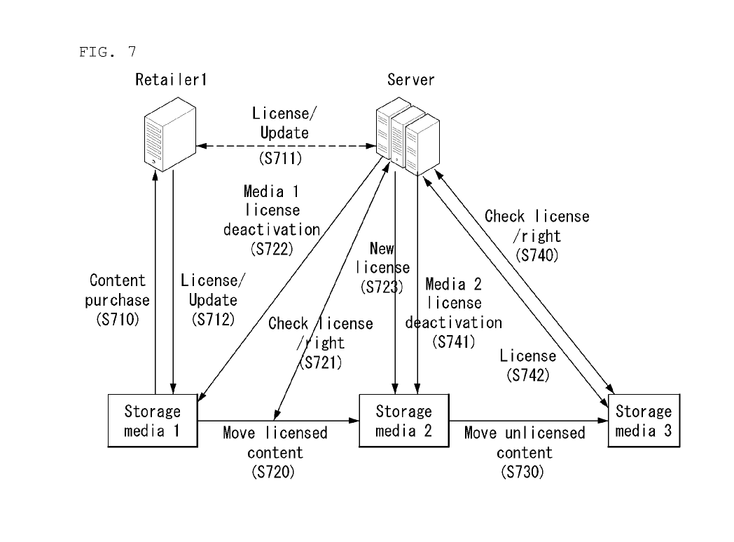

FIG. 7 is a flow diagram illustrating a process of licensed move and unlicensed move of secure HD content between storage devices according to an embodiment of the present invention.

The secure high definition content may be moved from one storage device to other storage device. Here, movement may refer to transfer of a content file to a destination storage media having an activated license. The movement may be performed by a playback device having capability of playing the secure high definition content. The destination storage media may be able to store the secure high definition content. Here, the server may provide the right to move content validly.

First, when the storage media 1 purchases secure high definition content from the retailer 1 (S710), the retailer 1 may report contents of the content purchase to the server. The server may provide a valid license regarding the content purchase to the retailer 1, and update a certificate list stored in the server (S711). Here, the certificate list may include at least one of a content title certificate list, a storage device certificate list, a playback device certificate list, and a license certificate list.

The retailer 1 may provide a valid license regarding the content purchase to the storage media 1, and update the certificate list stored in the retailer 1 (S712).

In another embodiment, in a case in which content properly purchased from the storage media 1 is intended to be moved to the storage media 2 (S720), the server may determine whether the storage media 2 has the right to move the content or whether the content may be copied (S721). When the storage media 2 has the right to move the content or the content may be moved according to the determination, movement of the content by the storage media 2 may be performed and the server may deactivate the license which has been provided to the storage media 1 (S722), and provide new license information for playing the content to the storage media 2 (S723).

In another embodiment, when the content is intended to be moved invalidly (unlicensed movement) from the storage media 2 to a storage media 3 (S730), only a data file of the content may be moved from the storage media 2 to the storage media 3 and a certification procedure through the server is not performed. However, when the storage media 3 intends to play the content, a new license may need to be issued.

In another embodiment, when the storage media 3 intends to play the content, the storage media 3 may request the right to play the content from the server (S740). Accordingly, the server may deactivate the license which has been provided to the storage media 2 (S741), and provide new license information for playing the content to the storage media 3 (S742).

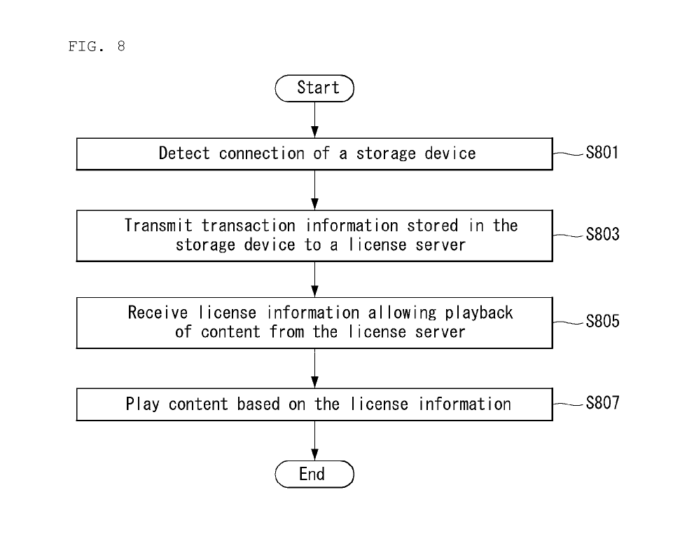

FIG. 8 is a flow diagram illustrating a process of obtaining license information for playing secure HD content stored in a storage device according to an embodiment of the present invention.

In order for the user to purchase HD content and play it in a playback device, the user needs to obtain at least one of transaction information and license information corresponding to the HD content.

First, when the storage device storing the secure HD content is plugged in to a playback device, the playback device may detect the plugged-in storage device (S801). When the storage device is detected, the playback device may transmit transaction information stored in the storage device to a license server (S803). Here, the transaction information may refer to information regarding content transaction activity, which may refer to aggregation information of right information. For example, the right information may be information indicating a status for issuing a license for a storage device. The transaction information may include transaction handle information identifying at least one of a corresponding transaction, a seller, and a user, and right information indicating a right information item of corresponding content. Here, the transaction handle information may provide a unique link regarding a corresponding transaction.

Upon receiving the transaction information, the license server may determine the right to play on the basis of the transaction information. When it is determined that the storage device has the right to play the HD content, the license server may generate right information and license information and transmit the generated right information and the license information to the storage device (S805). Here, the license information may be information allowing the purchased content to be played, and may include at least one of license file information and license key information.

The playback device may play the HD content on the basis of at least one of the right information and the license information (S807).

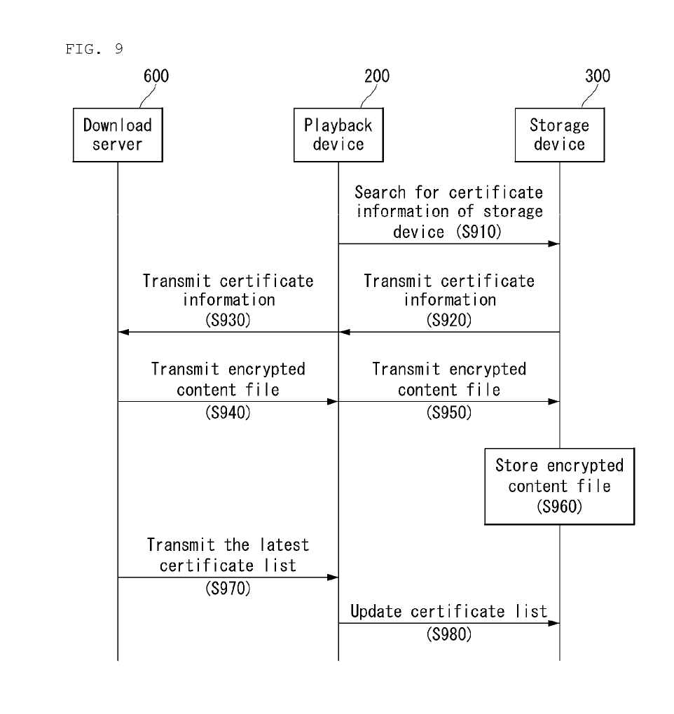

FIG. 9 is a flow diagram illustrating a process of providing content through a session established between devices according to an embodiment of the present invention.

In order to play secure HD content, a playback device 200 may use at least one of a certificate list, encryption information, device identification information, device certificate information, storage device certificate information, and storage device identification information.

First, when a storage device storing secure HD content is plugged into the playback device 200, the playback device 200 may request device certificate information of the storage device 300 from the storage device 300 (S910). Upon receiving the request for the device certificate information from the playback device 200, the storage device 300 transmits the device certificate information to the playback device 200 (S920), and the playback device 200 transmits the device certificate information to a download server 600 (S930). Here, the download server 600 refers to a server storing a content file and may include a certification server (not shown) for performing certification on content, a storage device, or a playback device.

Upon receiving the device certificate information from the storage device 300, the download server 600 may determine whether the device certificate information is valid. For example, the download server 600 may determine whether the received device certificate information is identical to any one of pieces of device certificate information managed by the download server 600. When the device certificate information from the storage device 300 is not valid according to the determination result, the playback device 200 cannot play the secure HD content.

In contrast, when the device certificate information from the storage device 300 is valid, the download server 600 transmits an encrypted content file to the playback device 200 (S940), and the playback device 200 transmits the encrypted content file to the storage device 300 (S950).

The storage device 300 may store the encrypted content file, and here, the received encrypted content file may be stored in a file system of the storage device 300 (S960).

The encrypted content file may include content level information, and the content level information indicates categorized content attribute information. The content file provided in the system to which the present invention is applied may be provided as a different profile according to the content level information. For example, in case the content level information is “Level 1”, the corresponding content may correspond to a standard definition (SD) profile, and in case the content level information is “Level 2”, the corresponding content may correspond to a high definition (HD) profile, and in case the content level information is “Level 3”, the corresponding content may correspond to a quad-high definition (QHD) profile.

Meanwhile, the playback device 200 may also be provided with various levels according to capability thereof. For example, in case the device level information indicates “Level 1”, the corresponding playback device may play content corresponding to “Level 1”; in case the device level information indicates “Level 2”, the corresponding playback device may play content corresponding to “Level 1” and Level 2″; and in case the device level information indicates “Level 3”, the corresponding playback device may play content corresponding to every content level information.

Meanwhile, the download server 600 transmits the certificate revision list to the storage device 300 (S970). Upon receiving the certificate revision list, the storage device 300 synchronizes the received certificate revision list with a previously stored certificate list to update the certificate list (S980). Here, the certificate list refers to a list of pieces of certificate information required for playing the secure HD content, and includes at least one of a content title certificate list, a storage device certificate list, a playback device certificate list, and a license certificate list, for example. The certificate list may be used to certify eligibility of at least one of the playback device, the storage device, and the server, and may be stored in a secure region of the storage device.

Since the certificate list of the storage device 300 is updated as described above, a secure session may be established between the storage device 300 and the playback device 200 or between the storage device 300 and the download server 600, and secure information such as a license key may be transmitted and received through the secure session.

Thus, on the basis of the updated certificate list, the playback device 200 may play the encrypted content file stored in the storage device 300. The encrypted content file may be played on the basis of a specific application installed in the playback device 200.

As described above, a session is established when information is transmitted between devices belonging to the system to which the present invention is applied, a command may be transmitted through the session, and a response may be received in response to the transmitted command. At this time, the session may be identified by session identification information, and the session identification information may be defined by being classified according to whether key information for protecting content is exchanged or indicate whether key information for protecting content is exchanged.

For example, the session identification information may indicate one of at least two types of session states, where the at least two types of session states may include a secure session and a non-secure session. At this time, a secure session indicates a session in which exchange of key information for protecting content is allowed, while a non-secure session indicates a session in which exchange of key information for protecting content is not allowed. In other words, in the case of a non-secure session, a command independent of a certification process for exchanging key information is allowed.

At this time, the secure and non-secure session are the terms introduced for the purpose of describing the present invention, and the two terms may be replaced with other terms having the same implication. For example, the two terms may be called a local session and a network session, respectively.

As an embodiment of the present invention, the session identification information may be expressed by a hexadecimal number. For example, a first session identification information indicating a secure session may be expressed by 0x0001, while a second session identification information indicating a non-secure session may be expressed by 0x0000.

Meanwhile, the session identification information may be transmitted by being included in a response message responding to the command. The session identification information included in the command may indicate a session identifier assigned by a storage device, and the session identification information included in the response message responding to the command may have the same value as the session identification information included in the command.

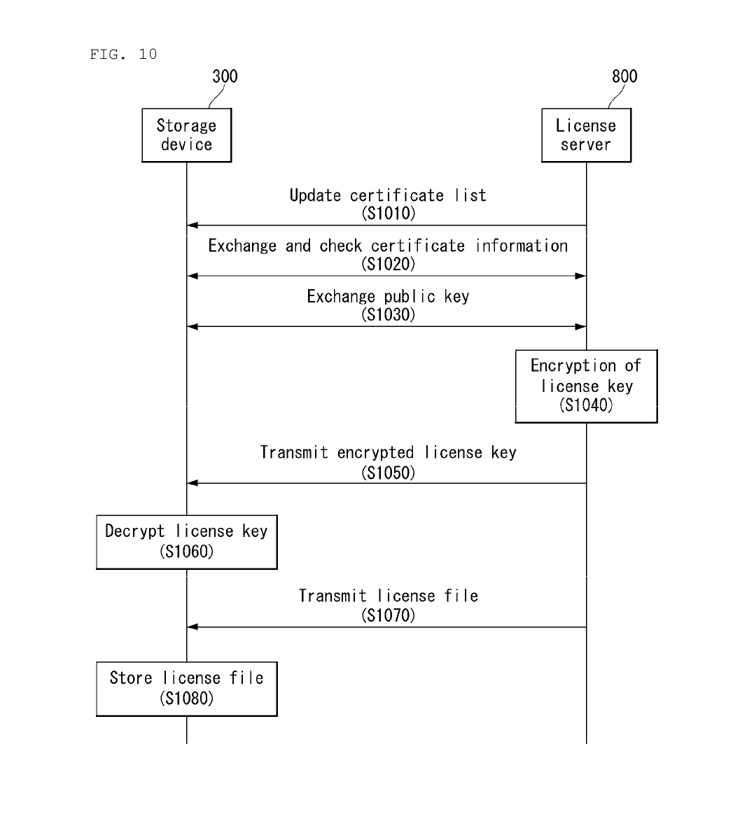

FIG. 10 is a flow diagram illustrating a process of providing license information through a session established between devices according to an embodiment of the present invention.

In order to play an encrypted content file stored in the file system of a storage device, the storage device needs to obtain license information. FIG. 10 describes a process for a storage device to obtain license information.

To obtain license information, the storage device 300 may first connect to a license server 800. At this time, the storage device 300 may be connected through a playback device. The license server 800 may receive a certificate list of the storage device 300 from the storage device 300 and check whether the certificate list is the latest one. When the certificate list of the storage device 300 is not the latest one according to the checking result, the license server 800 may request the storage device 300 to update the certificate list (S1010). At this time, the certificate list may be the latest certificate list obtained from a key issuance center.

The storage device 300 may update a pre-stored certificate list by receiving the latest certificate list and synchronizing it with the pre-stored certificate list. Here, a certificate list refers to a list of certificate information required to play secure HD content; for example, the certificate list may include at least one of a content title certificate list, storage device certificate list, playback device certificate list, and license certificate list. The certificate list may be used for certifying eligibility of at least one of a playback device, storage device, and server; and may be stored in a secure area of the storage device.

And the license server 800 and the storage device 300 may confirm whether the storage device 300 is a certified storage device by exchanging certificate information of the storage device 300 (S1020). Afterwards, the license server 800 and the storage device 300 may exchange a public key (S1030).

After exchanging a public key, the license server 800 may encrypt a license key (S1040). The license server 800 may transmit the encrypted license key and the license file to the storage device 300 (S1050, S1070).

The storage device 300 which has received the encrypted license key and the license file decodes the encrypted license key (S1060) and stores the license file into the secure area of the storage device 300 (S1080).

As described above, according as the certificate list of the storage device 300 is updated, a secure session may be created between the storage device 300 and the license server 800, and security information such as the license key may be transmitted and received through the secure session. Therefore, based on the update of the certificate list, the playback device may play the encrypted content file stored in the storage device 300.

FIG. 11 illustrates internal functional block diagrams of a playback device and an certification device for managing content playback right according to an embodiment of the present invention.

A storage device 200 and a certification device 1100 according to the present invention perform a connection setup so that they can be linked to each other through a network, transmit and receive a request message and a response message when they are linked to each other through the network connection, and continuously output content by periodically checking whether the network connection is maintained.

The playback device may largely include a storage device managing unit 291, playback device managing unit 292, security protocol managing unit 293, certification device managing unit 294, and encryption managing unit 295.

The storage device managing unit 291 performs the role of detecting connection and separation of a storage device and providing a security protocol command API.

The playback device managing unit 292 may perform a control command such as playback and termination of content in association with the content license managing unit, security protocol managing unit, and certification device managing unit.

The security protocol managing unit 293 performs the role of processing a security protocol such as provision of a license and provision of playback right.

The certification device managing unit 294 may periodically check whether a connection between the playback device and certification device is maintained, and in case the connection is lost, transmit an event message to the playback device by generating an event. And in the presence of a plurality of certification devices, a list for managing the plurality of certification devices may be created.

The encryption managing unit 295 may perform an encryption-related function by calling the API of the encryption module.

The certification device 1100 may include a content license managing unit 1101, license update managing unit 1102, and certification key managing unit 1103.

The content license managing unit 1101 may manage a list of contents having a playback right and transmit a content license list upon receiving a playback right confirmation request from a playback device.

The license update managing unit 1102 may update the certification key by checking change of a content license. For example, if the user purchases a new content, the license update managing unit 1102 may add the purchased content to the list of the content license managing unit 1101. Also, if the valid period of the content purchased by the user expires, the license update managing unit 1102 may delete the corresponding content from the content list of the content license managing unit 1101.

The certification key managing unit 1103 may perform the role of storing and managing a certification key required when applying a protocol between a playback device and a storage device.

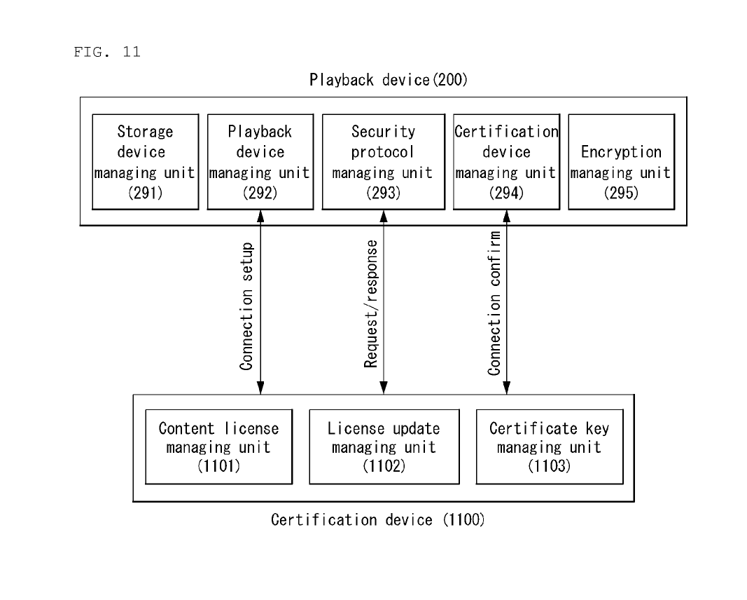

FIG. 12 illustrates a data structure defining a rights field for loan or return of content within a transaction identification file(Transaction Handle) according to an embodiment of the present invention.

The content stored in the conventional SD, USB memory, or HDD does not support a loan function. In case a loan function is supported, content is not played in the original storage but may be played only in a loan storage. Therefore, the license of the content is temporarily deactivated in the original storage but needs to be activated in the loan storage. Also, when the content is returned, only the license related to the content in the original storage has to be activated. In case content is loaned or returned as described above, to implement the loan or return function while protecting the content, it is necessary to define a function for temporarily activating or deactivating a license, a function for automatically activating or deactivating the license when a load period of the content is passed, and a function for the original storage to request return of the content during the loan period.

A playback device according to the present invention may have a secure memory area in the playback device in which a license may be stored. The secure memory area may include return information of a content right as well as a playback right for a content profile and the corresponding content.

The present invention may define the loan or return concept for a content playback right by defining start/end date of playback of contents, check in/check out of the playback right of the contents, and a key for exchanging the right.

According to one embodiment of the present invention, contents in the original storage may be loaned to another storage along with a license. When contents are loaned, the original license is deactivated, making the contents in the original storage deactivated from being played.

And if a loan period is terminated, the license in the original storage is activated again, and the license stored in the loan storage is deactivated again. Also, the original storage may perform termination of the loan period any time.

Also, the content information may include an original copy or a loan copy; the content license information may include a loan period or use period for the license. During the loan period, the original license may be activated or deactivated according as the loan period is checked. The original content may request withdrawal of the license for the loan content and prevent multiple loans of the content to various other storage media.

Also, the present invention may define metadata and right information about the content in the secure storage of the present invention. For example, the right information may include at least one of a storage CRL, player CRL, title CRL, address information, key set, loan release date, loan expiry date, and loan release key.

Also, the present invention may define a transaction identification file(Transaction Handle) for purchase information, and the transaction identification file may include a loan right or return right.

Also, the present invention may define a playback device that lends and get back a content playback right. For example, the player level may be validated through a player CRL, after which a playback device may be determined according to the loan right given to the device about whether it is capable of playing the corresponding content. The present invention may validate the output control of the loan right and validate a playback map after generating the playback map by using the loan right.

Also, the present invention may define the items that are required to return the content playback right for the original playback device. For example, in order to return the content playback right, the present invention may define a license transaction record, device ID, CRL, and license release date.

The present invention may be applied to all kinds of secure storage systems and also applied to playback of various codecs (MPEG-2,4,AVC, HEVC, VC-1) and trick play. Also, the present invention may be extended to streaming-type transmission in addition to file play.

The present invention may extend the method for providing a content playback function in a AVC/HEVC stream-based media service. To this purpose, it is necessary to define a key, license release date, and license expiry date for delivering a content playback right to other playback devices as well as the original playback device. The present invention may validate player level and output control information to check whether there is a problem in creating a playback map through one purchase information in a secure storage system to which details of the corresponding right has been applied. And to deliver the right again to the original playback device, the present invention may check the transaction record of the license server and deliver the license to the original playback device afterwards.

In one embodiment of the present invention, a storage may be a secure storage (for example, SCSA storage) to lend a license from a storage A to a storage B. As shown in FIG. 12, to check whether the license of the content in a storage is the original copy or a loan copy, a rights field S1200 may be added to the transaction identification file used for communicating with a license server. In case the rights field value is 0, it indicates that the contents license is the original copy, whereas it indicates that the license is a loan copy in case the rights field is 1. Also, the transaction identification file(Transaction Handle) may include at least one of transaction handle information, title, and transaction ID.

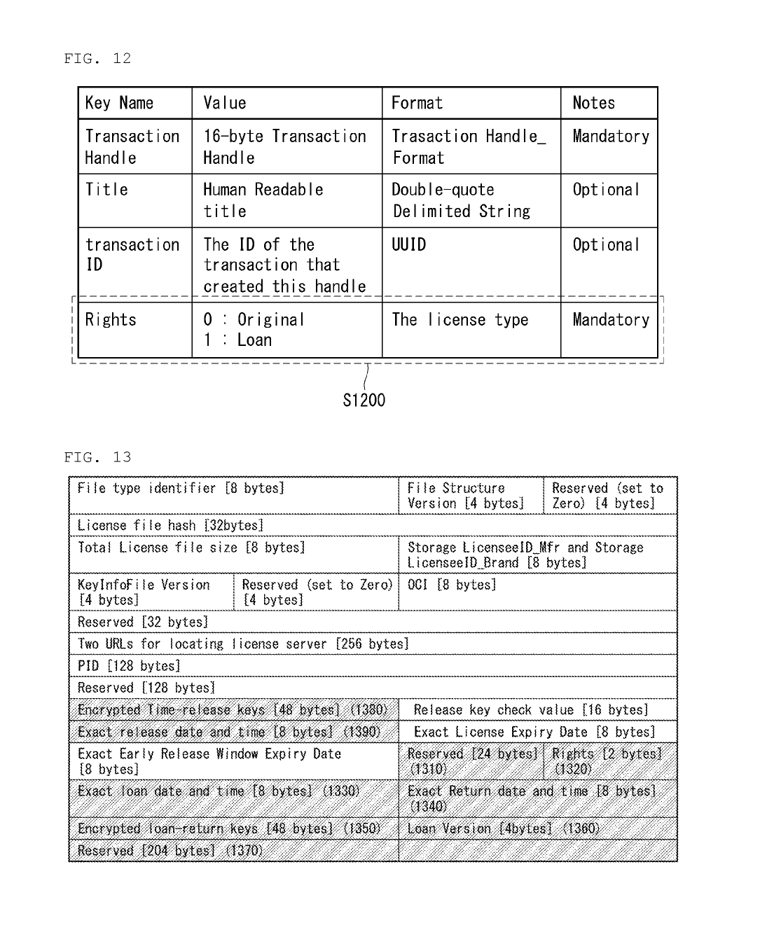

FIG. 13 illustrates a data structure defining a rights field for loan or return of content within a license file, period field, encryption key field, and version field according to an embodiment of the present invention.

The rights field in the transaction identification file(Transaction Handle) may be replaced with other field within the license file.

Referring to FIG. 13, the present invention may add a field value, of which the identification number ranges from 1310 to 1370, to the structure of the license file system which contains the license information of content. For example, the added field may include at least one of a reserved field 1310, rights field 1320, loan start time field 1330, loan return time field 1340, encrypted loan return key field 1350, loan version field 1360, and additional reserved field 1370.

Meanwhile, the exact release data and time field 1390 within the corresponding file may be used after being decrypted by using the time-release keys 1380 to enhance security. The loan/return time field value may be determined by comparing the exact release data and time field 1390 with the time-release keys 1380.

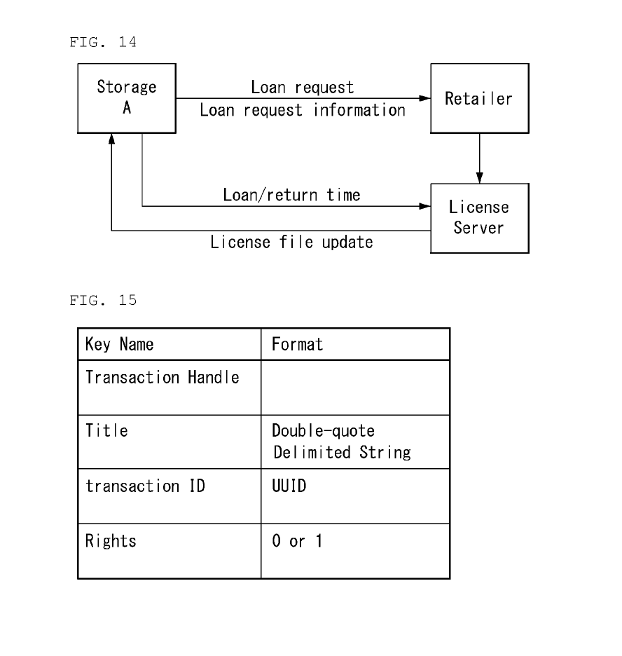

FIG. 14 is a block diagram illustrating a process of loaning secure HD content from the viewpoint of a source storage device according to an embodiment of the present invention.

Referring to FIG. 14, A represents the original storage, and B represents a loan storage.

First, the original storage A may request a loan from the retailer. At this time, information of a person who loans the content or information of the original storage A which requests a loan may be provided to the retailer, and loan/return time may be set to the license server. Receiving a loan request, the retailer may transmit load request information to the license server.

The license server goes through a license provision process and updates a license file within the license server, in which the loan/return time field value is registered, for the original storage A.

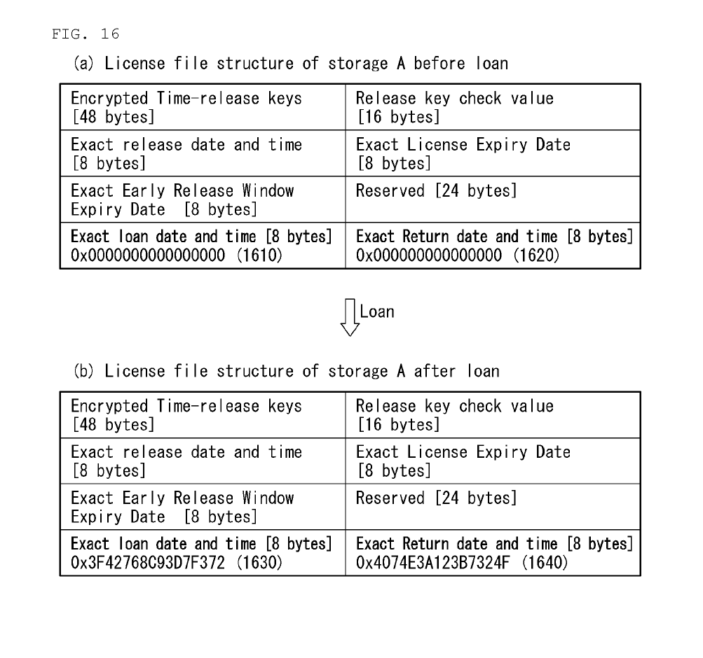

FIG. 15 illustrates a structure of a transaction identification file used when loaning of secure HD content is performed according to an embodiment of the present invention.

In one embodiment of the present invention, as shown in FIG. 15, the structure of the transaction identification file(Transaction Handle) may be defined. The transaction identification file(Transaction Handle) may include at least one of a transaction handle field, title field, transaction ID, and rights field.

The transaction identification file(Transaction Handle) may be used for communicating with a license server to check whether the license of the content in a storage is the original copy or a loan copy.

For example, in case the rights field is 0, it indicates that a content license is the original copy, whereas it indicates that the content license is a loan copy in case the rights field is 1.

Also, the rights field may indicate whether a loan of the content license is possible or not.

FIG. 16 illustrates a structure of a license file before and after loan of secure HD content according to an embodiment of the present invention.

FIG. 16 illustrates the structure of a license file stored in the original storage A of FIG. 14. The license file may include an exact loan date and time field and exact return date and time field.

FIG. 16(a) illustrates the structure of a license file before a content is loaned from the original storage A. Since the license file in the original storage A is active before the loan, the exact loan date and time field 1610 may be expressed as 0x0000000000000000, and the exact return date and time field 1620 may be expressed as 0x000000000000000.

FIG. 16(b) illustrates the structure of a license file after content is loaned from the original storage A. Since the license file is related to the structure after the loan, the exact loan date and time field 1630 may be expressed as 0x3F42768C93D7F372, and the exact return date and time field 1640 may be expressed as 0x4074E3A123B7324F.

In case the field value as recommended in FIG. 15 is 0, the content may not be played between the loan time and the return time. Also, the exact loan date and time field 1630 and the exact return date and time field 1640 may be encrypted by using the encrypted time-release key field value.

FIG. 17 is a block diagram illustrating a process of loaning secure HD content from the viewpoint of a loan storage device according to an embodiment of the present invention.

Referring to FIG. 17, B represents a loan storage, and the figure illustrates a process in which a license and contents are downloaded from the loan storage B.

In case the corresponding content is loaned from the loan storage B, the loan storage B may request the retailer for download of the content and receive from the license server at least one of a transaction identification file(Transaction Handle), license file, and license key of the corresponding content.

This scheme may prevent license-related information from being mixed together when content is loaned from other user (or storage) rather than the original storage A.

In order for the loan storage B to rent content, the loan storage B has to receive the license-related information and to this purpose, the original storage A needs to be informed that the loan storage B is allowed to rent content from the original storage A. For example, it may be proved that the loan storage B is a certified storage (or user) through a storage (or user) ID from the retailer.

In case certification is performed by the retailer, at least one of the transaction identification file, license file, and license key may be downloaded through the license server. At this time, the rights field value of the transaction identification file may be 1. And the loan storage B goes through the same process as the license provisioning process for general contents, and the license server sets the loan/return date and time field value of the license file and fills the field value with encrypted data by using a key value.

Now, a method for playing contents by using a loan license according to another embodiment of the present invention will be described. In case content is played by using the loan storage B, two different methods may be used as described below.

(1) In Case a Connection to the License Server is Needed

In case the rights field value of the transaction identification file(Transaction Handle) is 2, the loan storage B may connect to the license server to check whether loan of the corresponding license is still possible. In this case, even if the return date is not met, the original storage A may request return of the license. Even if the return date of the license file of the loan storage B is not passed, playback of the content may be disabled unless the license server requests for the loan.

In case content is played by using the loan storage B, the load storage B may connect to the license server to check whether the original storage A has requested return of the license. In case the original storage A has requested return of the license, the loan storage B may delete at least one of the license file, transaction identification file, and license key.

In case the original storage A requests return of the license and again loans the license to a second loan storage C, the first loan storage B may connect to the original storage A and play the content before the second loan storage C downloads the license information. Therefore, determination of the second loan storage is further required. To solve the problem above, the present invention may add a version field to the transaction identification file as shown in Table 1.

TABLE 1

| Key Name | Format |
|---|---|
| TransactionHandle | |
| Title | Double-quote |
| | Delimited String |
| transactionID | UUID |
| Rights | 0 |
| Loan Version | 1 |

The license server may increase the loan version by 1 each time the original storage A requests loan from the license server. And when the loan storage is connected and license is downloaded, the corresponding number may be inserted into the license file.

For example, in case the loan version of the first loan storage B is 100, and the original storage A request return of the license while still in use and loan the license to the second loan storage C, the loan version kept in the license server may become 101. At this time, since the loan version of the license server and the loan version of the first loan storage B do not coincide with each other, the corresponding content is not played. The corresponding content may be played only after the license is newly downloaded into the storage of the user allowed by the original storage A.

(2) In Case Content May be Played without a Connection to the License Server

In case playback of contents is allowed without a connection to the license server, the original storage A may not request return of the license before the return date of the license. In this case, loan or return of the license may be determined by the value set into the license file.

In case the rights field of the transaction identification file is 0, playback of content is not possible during the loan/return period specified in the license file. To play the corresponding contents, the original storage A has to request return of the license from the license server. On the contrary, in case the rights field is 1, the content may be played only during the loan/return period specified in the license file.

In case the return date is passed, at least one of the transaction identification file, license file, and license key may be deleted or deactivated from the storage through the playback device or the license server.

The license server may check the number in the rights field of the corresponding transaction identification file. In other words, when the content is purchased for the first time, the number of rights fields of the corresponding transaction handle field with a zero value is 1. Afterwards, the license is loaned, the number of is increases by 1. Through the scheme described above, how the license of contents is distributed may be monitored. The corresponding field may be extended for copy of the license afterwards, or the number of license copy may be limited.

The license loan may temporarily deactivate the license of the original storage and activates the license of the loan storage. And this eventually indicates that a license may not be loaned to a plurality of storages at the same time.

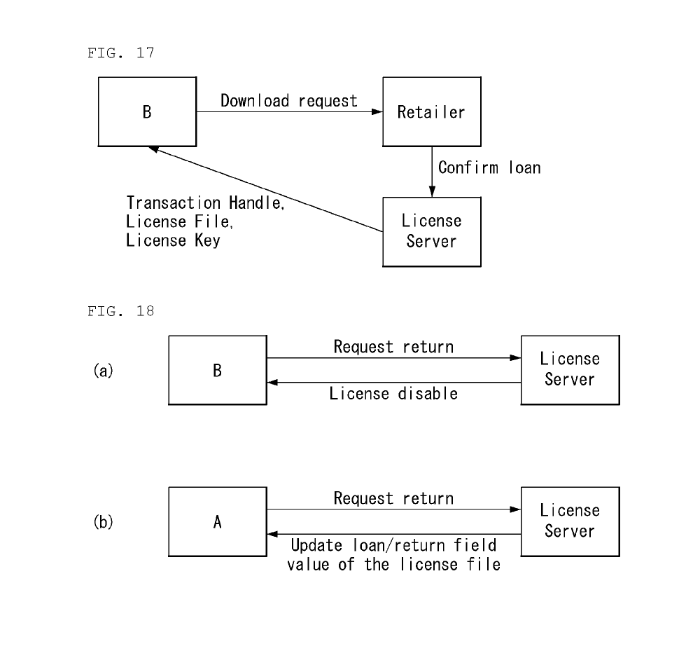

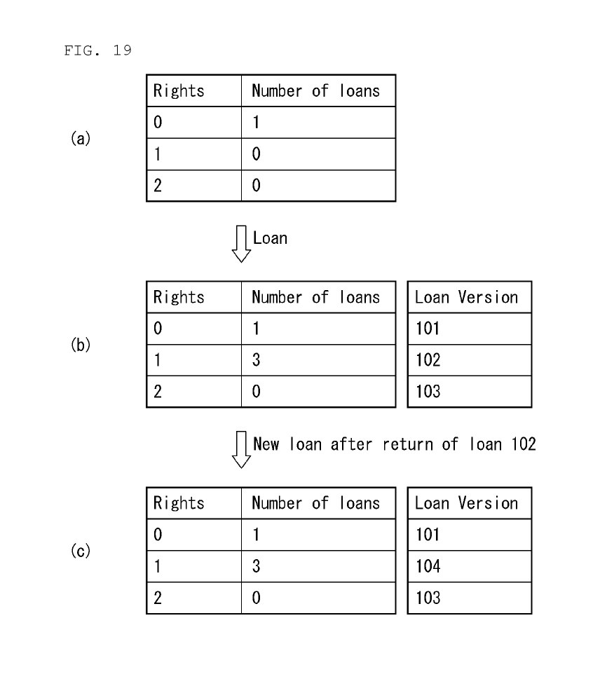

FIG. 18 is a block diagram illustrating a content return process of a source storage device and a loan storage device according to an embodiment of the present invention.

FIG. 18 illustrates a case in which a loan storage request an early return of content. In other words, the loan storage may return the loan license before the return time set to the license.

For example, as shown in FIG. 18(a), the loan storage B may request an early return of the license before the return time. In case the loan storage B requests return of the license from the license server, the license server may deactivate the license for the corresponding contents of the loan storage B or invalidate the function of the corresponding license by deleting at least one of the transaction identification file, license file, and license key, for example.

Referring to FIG. 18(b), in case the original storage A plays the contents afterwards, a request for return of the license is recognized if the original storage A is connected to the license server, the license file is updated, and the corresponding contents may be played through the original storage A.

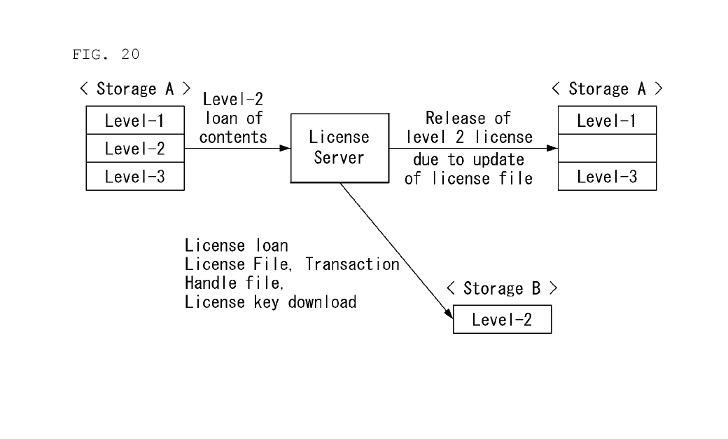

FIG. 19 illustrates a process of checking version information in case multiple loans are allowed according to an embodiment of the present invention.

In the embodiment of the present invention, in case multiple loans are allowed, the license server may have currently allowed loan version information. Contents may be made to play contents only for the current loan version. The loan version may be checked through a connection to the license server.

In case a connection to the license server is not mandatory for multiple loans, the loan version and how many storages the license of the corresponding content are loaned may be determined when the loan right for the corresponding contents is requested. Therefore, when the corresponding license is loaned through the license server, the number of downloads of the license may be counted, and downloads may be performed only as many times as the number of loans initially specified.

For example, referring to FIG. 19, if it is assumed that the license server manages three loan rights for the corresponding contents (right 0, 1, and 2), distribution of the content license managed by the license server may be checked.

FIG. 19(a) illustrates a case in which the number of loans for the right 0 is 1, and for the case of FIG. 19(b), the number of loans for the right 1 is 3. At this time, loan version may be checked for each of the right 0, 1, and 2. For example, in the case of right 0, loan version is 101; in the case of right 1, loan version is 102; and in the case of right 3, the loan version is 103.

FIG. 19(c) illustrates a case in which the loan version is updated when the right for the loan version 102 is returned and loaned again. For example, in the case of right 1, the loan version is updated from 102 to 104.

Also, when multiple loans are allowed, the loan/return time may not be specified so that the original storage may also be allowed to play contents.

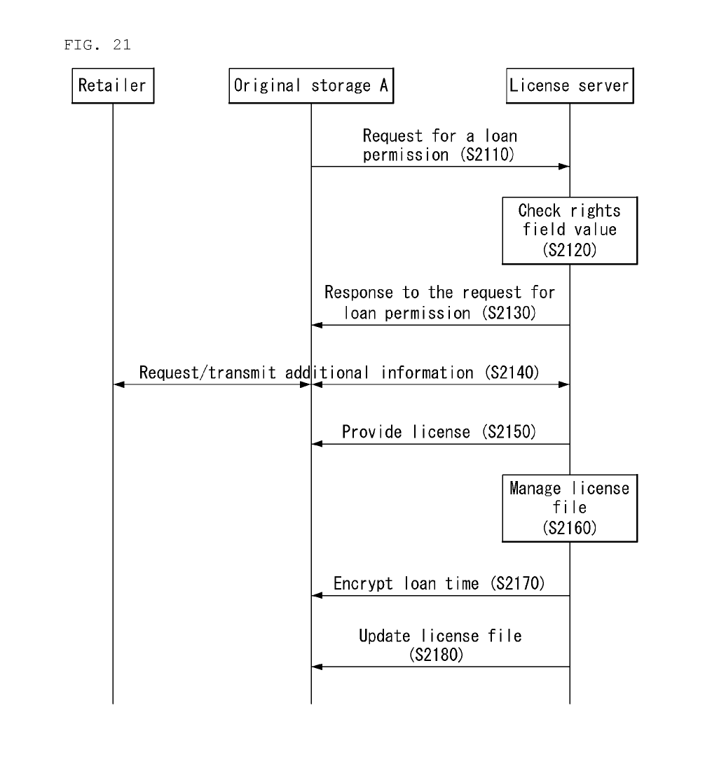

FIG. 20 illustrates a process of performing loan of secure HD content for each profile according to an embodiment of the present invention.

When purchasing content, there may be various profiles according to the quality of the corresponding content.

In case the corresponding content has multiple profiles, loan/return of a license may be requested selectively according to the respective profiles when the license is loaned. Since a license file exists for each profile, even if the content of level 1 is loaned from the storage A to the storage B, the storage A may play the content having a different profile.

For example, referring to FIG. 20, suppose the storage A includes content of three levels, and content of level 2 is loaned. In this case, the license server loans a license for the content of level 2 to the storage B, and the storage B may download, for example, at least one of a license file, transaction identification file, and license key from the license server.

Meanwhile, the license server may update the license file by releasing the license of level 2 of the storage A. At this time, though the storage A is unable to play the content of level 2, content of level 1 and level 3 may be played.

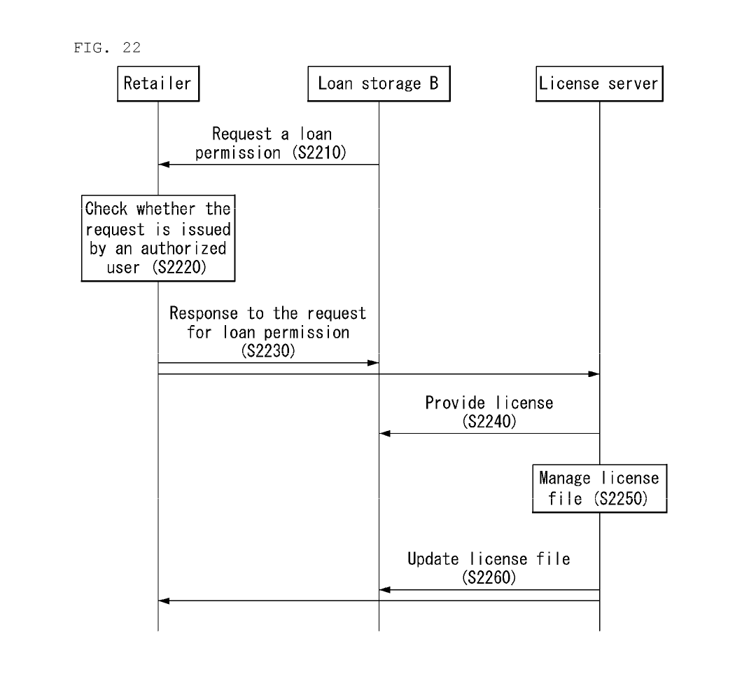

FIG. 21 is a flow diagram illustrating a process of loaning a license of secure HD content with respect to a source storage according to an embodiment of the present invention.

The original storage A may request a loan permission from the license server S2110. The license server which has received the loan permission request may check the rights field S2120. At this time, the rights field may be included in the transaction identification file(Transaction Handle); for example, if the rights field is 0, it indicates that the content license is the original copy, while, if the rights field is 1, it indicates that the content license is a loan copy. Or, the rights field may indicate whether a loan of a content license may be allowed or not.

The license server may transmit a response for the loan permission request to the original storage A. For example, in case the rights field is 0, the license server may transmit a response that the requested loan may be accommodated. On the other hand, in case the rights field is non-zero, it may indicate that the content license may not be the original copy, or since loan of the content license may not be possible, a response that loan of the content license is not possible may be transmitted to the original storage A.

As another embodiment, the original storage A may perform a loan permission request after checking the rights field by itself. For example, the original storage A may check that loan is allowed when the rights field within the transaction identification file(Transaction Handle) stored therein is 0 and request a loan permission from the license server.

The license server may request additional information from at least one of the retailer or the original storage A S2140, which may not be an essential operation. For example, the additional information may include at least one of user information and device information with respect to the original storage A.

And a license provisioning process may be performed between the original storage A and the license server S2150. Here, the license provisioning process refers to the process of exchanging license information required for playing encrypted content within a storage device, where the storage device has to possess a license file and a license key required for playback of contents.

The license server may manage license information of the original storage A S2160. For example, the license information of the original storage A may be changed, encrypted, or updated appropriately according to the situations. The license information may include at least one of the license file and the license key.

And the license server may encrypt loan time information of the original storage A S2170 and transmit the updated license file to the original storage A S2180.

FIG. 22 is a block diagram illustrating a process of loaning a license of secure HD content with respect to a loan storage according to an embodiment of the present invention.

The loan storage B may request a loan permission from the retailer S2210. The retailer that has received a loan permission request may check whether the loan storage B is an authorized user S2220.

The retailer may transmit a response with respect to the loan permission request to at least one of the loan storage B or license server S2230. For example, in case the loan storage B is an authorized user, the retailer may transmit a response to at least one of the loan storage B or license server that the request loan may be accommodated. On the other hand, in case the loan storage B is not an authorized user, the retailer may transmit a response to the loan storage B that the requested loan may not be accommodated.

As another embodiment, the loan storage B may request a loan permission from the license server. In this case, the license server may request additional information from at least one of the retailer or the loan storage B, which may not be an essential operation. For example, the additional information may include at least one of user information and device information about the loan storage B.

And the license provisioning process may be performed between the loan storage B and the license server S2240. Here, the license provisioning process refers to the process for exchanging license information required for playing encrypted contents within a storage device, where the storage device has to possess a license file and a license key required for playback of contents.

The license server may manage license information of the loan storage B S2250. For example, the license information of the loan storage B may be changed, encrypted, or updated appropriately according to the situations. The license information may include at least one of the license file and the license key.

And the license server may transmit to the loan storage B at least one of the encrypted loan time information or updated license file S2260.

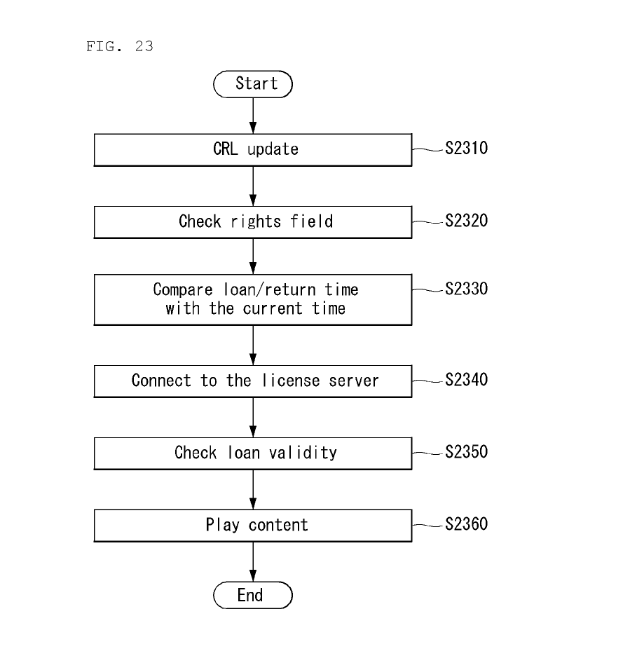

FIG. 23 is a flow diagram illustrating a process of playing secure HD content through accessing a license server with respect to a loan storage according to an embodiment of the present invention.

As shown in FIG. 22, in case a loan storage receives a loan permission from a retailer or a license server, the loan storage may play contents stored in the original storage.

First, the loan storage may update a CRL (Certificate Revision List) to play contents S2310.

And the loan storage may confirm the rights field within the transaction identification file by itself or through the license server S2320.

In case the rights field indicates a loan permission, the loan storage may compare the current time and the loan/return time S2330. When the current time belongs to the loan period according to the comparison result, the loan storage may play the contents.

At this time, in case it is essential for the loan storage to connect to the license server for playing contents, the loan storage has to connect to the license server S2340.

And the loan storage may check validity of a loan of contents S2350. For example, validity of the content loan may be determined by checking at least one of loan/return state and consistency of version information.

If the content loan is valid according to the determination result, the playback device may generate a playback map and play contents S2360.

Meanwhile, when the current time does not belong to the loan period according to the comparison result of the S2330 step, the loan storage cannot play contents. For example, when the current time passes the return time, the license server may delete or deactivate the corresponding license information.

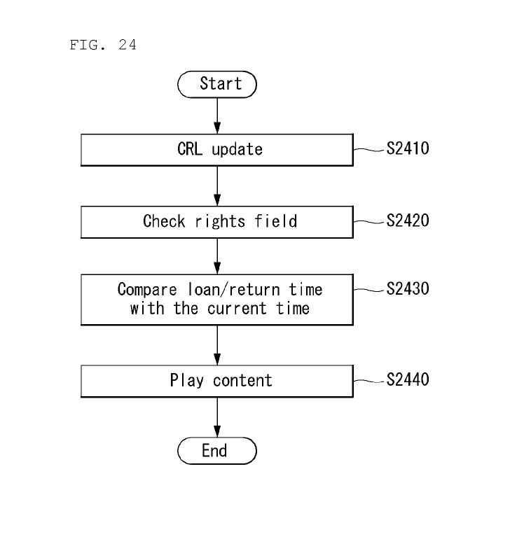

FIG. 24 is a flow diagram illustrating a process of playing secure HD content without accessing a license server with respect to a loan storage according to an embodiment of the present invention.

Different from the embodiment of FIG. 23, the present embodiment describes a method for playing secure HD content without accessing a license server.

First, the loan storage may update the CRL (Certificate Revision List) for playback of contents. S2410.

And the loan storage may check the rights field value of the transaction identification file by itself or through the license server S2420.

In case the rights field indicates that a loan is allowed, the current time and loan/return time may be compared with each other S2430. When the current time belongs to a loan period according to the comparison result, the playback device may play contents through the loan storage S2450. In other words, different from the embodiment of FIG. 23, if the current time belongs to the loan period, it is determined that content loan is valid, a playback map may be generated, and contents may be played.

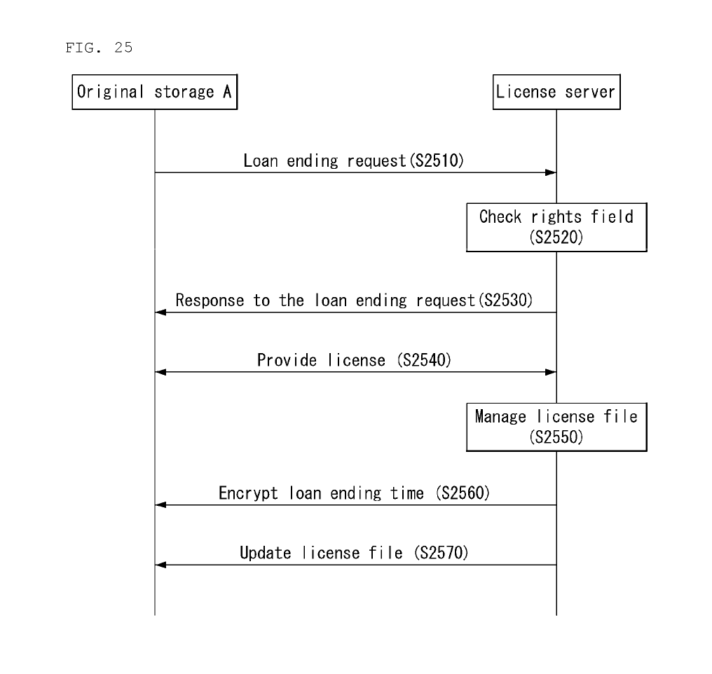

FIG. 25 is a flow diagram illustrating a process of terminating loan of secure HD content with respect to a source storage according to an embodiment of the present invention.

The original storage A may request the license server to terminate a loan of license S2510. The license server which has receive a loan ending request may check the rights field value S2520. At this time, the rights field may be included in the transaction identification file(Transaction Handle), and for example, the rights field may indicate whether loan of a content license is allowed or not.

The license server may transmit a response to the loan ending request to the original storage A S2530. For example, if the rights field values is non-zero, the license server may transmit a response that termination of loan of content license is not possible.

On the other hand, if the rights field value is 0, the license server may perform a process of terminating loan of content license according to the termination request.

As another embodiment, the original storage A may check the rights field value by itself and perform the loan ending request afterwards. For example, the original storage A may check the current loan state in case the rights field value within the transaction identification file(Transaction Handle) stored in the original storage A and request loan ending from the license server.

The license server may request additional information from at least one of the retailer or the original storage A, which may not be an essential operation. For example, the additional information may include at least one of user information and device information with respect to the original storage A.

And a license provisioning process may be performed between the original storage A and the license server S2540. Here, the license provisioning process refers to the process of exchanging license information required for playing encrypted content within a storage device, where the storage device has to possess a license file and a license key required for playback of contents.

The license server may manage license information of the original storage A S2550. For example, the license information of the original storage A may be changed, encrypted, or updated appropriately according to the situations. The license information may include at least one of the license file and the license key.

And the license server may encrypt loan ending time information of the original storage A S2560 and transmit the updated license file to the original storage A S2570.

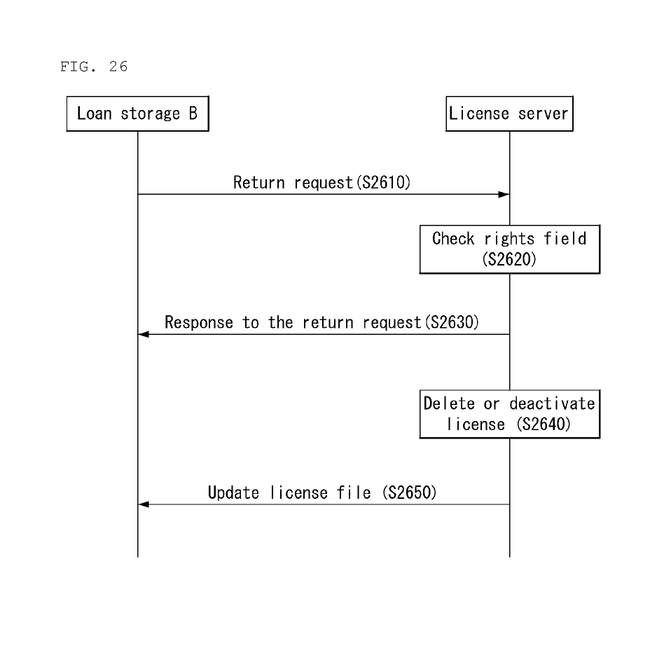

FIG. 26 is a flow diagram illustrating a process of performing an early return with respect to a loan storage according to an embodiment of the present invention.

Referring to FIG. 26, the loan storage B may request an early return of contents from the license server S2610.

The license server which has received a return request may check the rights field value S2620. Here, the rights field may be included in the transaction identification file(Transaction Handle), and for example, the rights field may indicate whether return of a content license is allowed or not. As a specific example, if the rights field value is 2, the license server may perform a return process.

The license server may transmit a response with respect to the return request to the loan storage B S2630. For example, in case the rights field value is non-zero, the license server may transmit a response that return of content license is not possible.

On the other hand, in case the rights field values is 2, the license server may perform a return process according to the return request.

As another embodiment, the loan storage B may check the rights field value by itself and perform a loan ending request afterwards. For example, in case the rights field value in the transaction identification file(Transaction Handle) stored in the loan storage B is 2, the loan storage B may check whether return of content license is possible and request return of content license from the license server.

The license server may manage license information of the loan storage B S2640. For example, the license information of the loan storage B may be changed, encrypted, or updated appropriately according to the situations. The license information may include at least one of the license file and the license key.

And the license server may transmit updated license information to the loan storage B S2650. As a specific example, the license server may delete or deactivate at least one of the transaction information, license file, or license key.

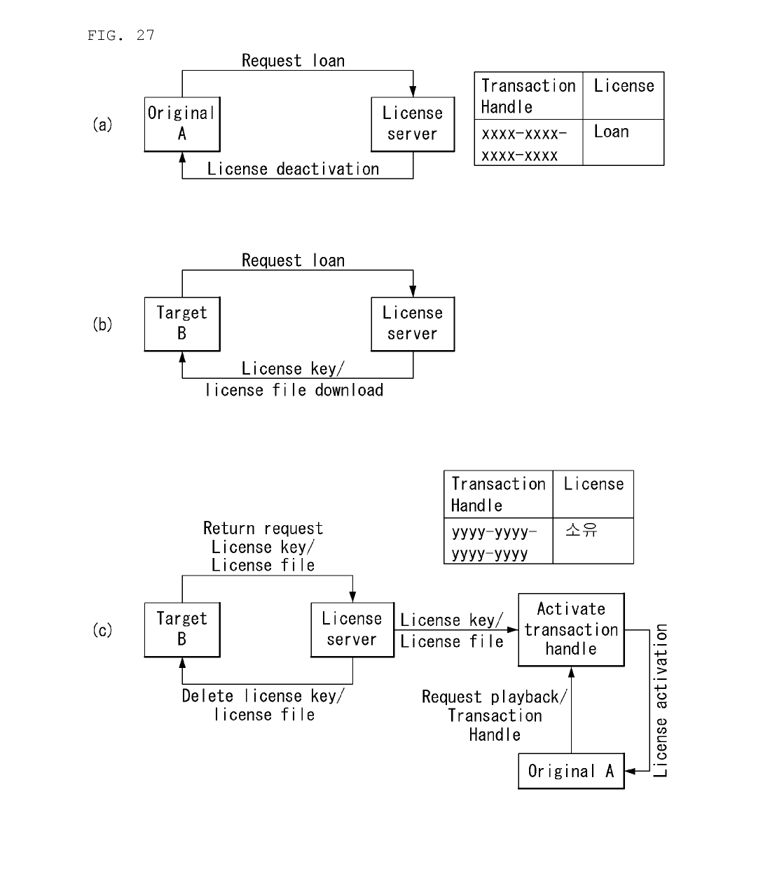

FIG. 27 is a block diagram illustrating a process of content loan and return with respect to a source storage and a loan storage according to another embodiment of the present invention.

FIG. 27(a) illustrates an embodiment in which, in case the original storage A makes a loan request, the license server deactivates the license of the original storage A. At this time, the transaction handle of the license is expressed as “xxxx-xxxx-xxxx-xxxx”, which indicates that the license is in a “loan state”.

FIG. 27(b) illustrates an embodiment in which, in case a target storage B makes a loan request, the target storage B downloads license information, for example, at least one of transaction information, license file, and license key from the license server.

FIG. 27(c) illustrates an embodiment in which, in case the target storage B makes a return request, the license server deletes or deactivates the license of the target storage B and activates the license of the original storage A. At this time, the transaction handle of the license is expressed as “yyyy-yyyy-yyyy-yyyy”, which indicates that the license is in a “owned state”.

Loan/Return Embodiments

A source storage or original storage may force the loan storage or target storage to return the license, but the present invention is not limited to the aforementioned case.

For example, in case a load period or other return method is not defined, the source storage may not receive the license until the loan storage returns the license within a specified period

When the license is returned, in order to deactivate the license currently used by the loan storage, a transaction number or transaction handle information may be required from the license server. At this time, the transaction number or transaction handle information may be stored in the license server and mapped to a license file or license key.

In case the target storage does not have a transaction identification file(Transaction Handle), the target storage may deactivate the license owned by the license server or unbind a connection to the license server.

Meanwhile, the license server may configure restrictions on the license loan.

For example, the license server may restrict at least one of the number of loans, loan period, loan area, or the number of loan storages. The restriction may be configured for a specific period. For example, in the case of loan area, the license server may set the loan area so that a license may be loaned only among storages belonging to a home network, and the storages are automatically unbound from a connection after the license is returned.

Also, a connection unbind from an existing right may be deactivated without involving the transaction identification file. In case there is no transaction identification file within a loan storage when the loan storage attempts to return a license, the license server may control binding/unbinding of transaction number and license information through a transaction record.

As another embodiment of the present invention, in case a source storage A and a target storage B are connected to the same player, they may be regarded as the devices belonging to the same network, and a license may be loaned to the target storage B through a transaction identification file of the source storage A. At this time, the transaction identification file may be stored in an ordinary file system based on non-SCSA storage or a file system based on SCSA storage.

Also, the transaction identification file within the source storage may be copied to the target storage before the loan process is initiated and delivered to the license server through the retailer.

As another embodiment of the present invention, a method for delivering a transaction identification file is provided.

In case a transaction identification file exists in the source storage, a license may be loaned to the target storage through a secure connection between a storage and the retailer, between the storage and the license server, between the player and the retailer, or between the player and the license server; or through the transaction identification file of the source player (or storage).

After confirming the transaction identification file of the source storage, the license server may transmit the license key and the license file. At this time, after creating a secure session between the license server and the target storage, the license server may deliver the license key and the license file from the license server to the target storage. At this time, the storage may be based on SCSA storage or non-SCSA storage.

As another embodiment of the present invention, a license file or transaction identification file in a conventional system may be retained to make loan/return of a license performed in a simple manner without modifying the conventional system. Thus, if an original storage is connected, a player displays that license loan is possible, and if loan is selected, the license may be loaned to a different player described above or other storage connected to the same player. The loan storage may download a license file or license key except for the transaction identification file containing purchase information (or transaction information).

The loan storage may play contents by using only the license file and license key without involving transaction information. After the loan, the license server deactivates the license of the original storage.

In the loan storage, a return button for the contents is activated on the player, and a return API of the license server is performed. During the process of returning a license, the license file and license key for the content of the loan storage are transmitted to the server, and the server may find the transaction handle by using the license file and the license key. In case the original storage is connected again to the license server to play the content, the license server may check that the license of the original storage has been returned and activate the license again. The license file and the license key of the loaned license may be deleted.

To determine whether the license has been loaned from a specific player, the corresponding license file may be marked, or a new file may be added to the content.

FIG. 28 is a flow diagram illustrating a process of delivering a transaction identification file to a license server according to an embodiment of the present invention.

Method for Delivering a Transaction Identification File to a Target Storage

In an embodiment of the present invention, in case a source storage A and a target storage B are connected to each other in a network, a license may be loaned to the target storage B based on the transaction identification file of the source storage A.

Also, the transaction identification file of the source storage may be copied to the target storage before a loan process is initiated and delivered to the license server through the retailer.

Method for Searching for a Transaction Identification File and Delivering the Transaction Identification File to a License Server

First, it may be checked whether there exist a transaction identification file in the source storage S2810. And whether to perform an additional search may be determined according to whether a transaction identification file of the source storage is detected or not.

When a transaction identification file is detected in the source storage S2820, the transaction identification file of the source storage may be delivered to the license server S2830.

However, in case a transaction identification file is not found within the source storage S2820, it may be checked through a target player S2840 whether there exists a transaction identification file in a target storage. When there exists the transaction identification file in the target storage, the transaction identification file of the target storage may be delivered to the license server S2850.

As an embodiment of the present invention, when there does not exist the transaction identification file, a device may record a transaction record through the license server.

Also, in case the transaction identification file exists only in the source player (for example, SCSA player) or source storage but does not exist in other target player or target storage, the target storage connected to the target player may store license information or license key, and a separate secure session may be needed for transmitting a transaction-related information or connection unbinding/deactivation of the license.

The license server may deactivate the target device or license of the target storage according to received transaction-related information. Afterwards, the license server may update the transaction record and update the transaction handle information of a source device.

In the present document, transaction-related information may include all kinds of information related to transactions such as license information, key value, storage information, and player information.

Also, the target device according to the present invention may indicate at least one of the target player or target storage, and the source device may indicate at least one of the source player or source storage. Also, a target player may be substituted for the target storage employed in the embodiments of the present invention and vice versa. A source player may be substituted for the source storage employed in the embodiments of the present invention and vice versa.

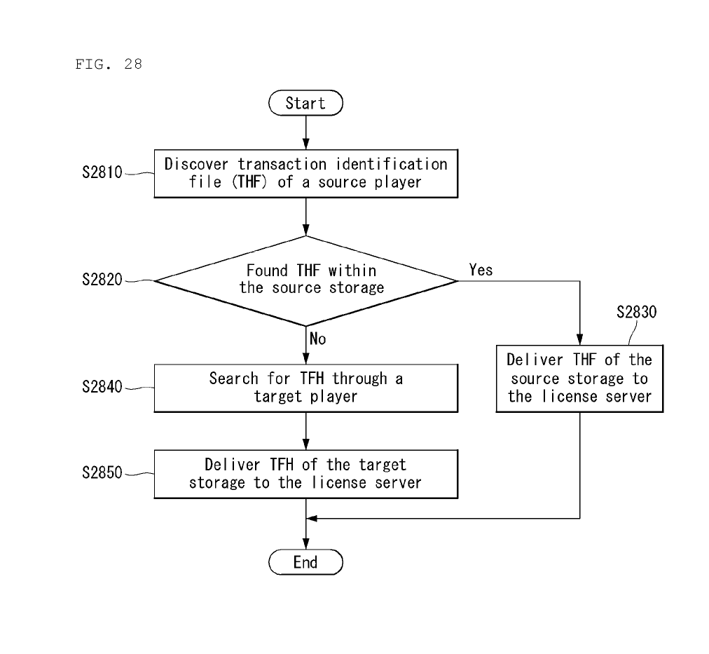

FIG. 29 is a block diagram illustrating a method for performing content library migration in case secure HD content is copied or moved according to an embodiment of the present invention.

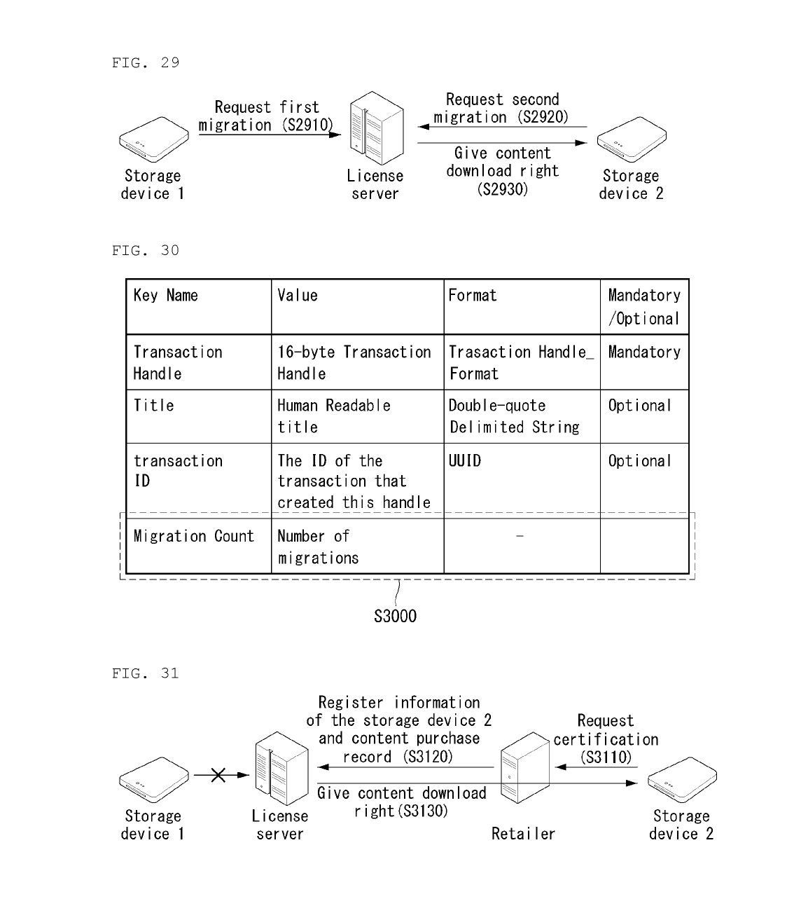

Referring to FIG. 30, storage device 1 copies or moves secure HD content to storage device 2.

First, the storage device 1 may request the license server to perform first migration to other device S2910.

And the storage device 2 may request the license server to perform second migration for downloading purchased contents S2920.

After checking the migration field of the transaction identification file of the corresponding contents, the license server may give the storage device 2 a content download right S2930.

Also, the present invention defines a structure for moving a contents library of an external storage device connected to a playback device to another secure external device when the playback device reads or plays contents from the secure external device connected to the playback device or server.

Also, the present invention may define a right for content use about contents library migration, history, right revision, expiry data, right release, and consecutive file transaction information of a storage-based secure contents playback system; and manage security information for playback of contents.

Conventional playback devices play contents by sharing HD contents (for example, UHD 4K or 8K video) with other playback devices by using a function of copying a contents right. In this case, a storage device, which has purchased the contents, holds license information with which the storage device may play contents and purchase information and is not obliged to have a particular limitation or definition on the corresponding library. However, it is necessary to move library information as well as contents right information to upgrade or replace a HDD.

Since the conventional devices may perform increasing or decreasing the number of copies or movements between HDDs without being imposed by a particular condition, there has been no definition related to a user's copy/movement of contents between HDDs. A concept of migration should be introduced to protect the rights of consumers who have purchased contents related to the user's copy/movement of contents among multiple HDDs.

According to the present invention, by defining migration of contents, contents may be moved among a plurality of HDDs owned by a single user, and the contents may be exchanged without causing an increase or decrease of the number of copies when the contents are copied.

Also, the present invention may solve the problems due to a lost or broken HDD.

Also, the present invention defines a migration target of a playback system including a secure storage.

Also, the present invention defines a library object to be migrated and a library migration error code.

Also, the present invention defines new field values about migration within a transaction identification file(Transaction Handle).

Also, the present invention may be applied to all of secure systems based on a secure storage system and may be applied to all of AVC or HEVC play and trick play.

Also, the present invention may be extended to other types of streaming-based transmission in addition to file play.

Also, the present invention may define a migration target of a playback system including a secure storage, namely a scenario about presentation. For example, in case a presentation collection ID (in what follows, it is denoted as ‘PCID’) already includes a PID (Presentation ID), migration may be performed excluding a duplicate ID. Similarly, in case the PCID already includes a PID, a separate alarm message may be used to determine whether to duplicate migration or to perform migration excluding the duplicate PID.

Also, the present invention may define various scenarios of migration.

For example, for HDD upgrade and replacement, all of the objects related to playback of contents may be moved from one storage device to another. Here, library migration objects may include a content file, transaction identification file, license file, consecutive file, playback map, CRL, and Ops block.

Also, the present invention may define library migration elements.

Migration elements may include a player (or conduit), storage device, and license server.

Also, the present invention provides an embodiment of migration considered when contents are purchased through separate retailers.

For example, in case the PCID already has a PID, a duplicate PID is formed, and the duplicate PID corresponds to the contents obtained through a single retailer, migration may be performed after the duplicate PID is removed.

On the other hand, in case a duplicate PID is obtained through separate retailers, migration may be performed so that the duplicate PID is also moved.

Also, the present invention provides an embodiment of migration considered when a license is downloaded through different license servers.

For example, in case the PCID already include a PID, a duplicate PID is formed, and the duplicate PID corresponds to the contents obtained through a single license server, migration may be performed after the duplicate PID is removed.

On the other hand, in case a duplicate PID is formed through separate license servers, migration may be performed so that the duplicate PID is also moved.

Also, the present invention may perform migration to prevent misuse of contents when an HDD is lost.

For example, by adding a field related to migration, an operation may be determined whether it is migration or not. If an HDD is lost, the lost HDD may be made unusable by registering in the license server at least one of a content file, transaction identification file, license file, and consecutive file about the lost HDD.

Also, the present invention may define the range of a library for migration.

For example, the range may be divided into the case for a storage having the same capacity as that of the original storage when migration is performed and the case for a storage having a different capacity from that of the original storage. In other words, migration for the case in which the capacity of the original storage is larger than that of the storage to which the contents is supposed to be moved may be separately handled.

Also, when migration is performed, it may assumed that a single title is migrated.

In case migration is performed for all of the titles, capacity of a storage needs to be checked, specifying a migration library range may be required, or defining a bulk area may be required.

In this case, library migration may be performed only for a selected title. Similarly, it is also possible to delete part of the titles after library migration. If a title is to be deleted after migration, a transaction identification file, license file, and so on may also be moved together.

Also, the present invention may define a bundle field for migration. For example, a bundle ID for migration may be defined, and a bundle may indicate a package encompassing the media level 1 to 3 of a specific contents title.

Also, according to the present invention, a storage device having a separate secure area may have purchase information and right information about contents in the secure area, and a connected playback device may play secure contents.

A storage device needs to provide a playback device with purchase information-based license information and information about a specific right to associate the corresponding right information. In case the storage device is upgraded, or a broken storage device is replaced, library migration is required.

Library migration may indicate moving a transaction identification file, license file, consecutive file, and the like from one storage device to another. At this time, the objects to be moved may include a generation map, CRL, and Ops block. If library migration is defined in this manner, content play may be enabled in a smooth manner through a valid library. Through a valid library verification field, a license file, CRL, encrypted content file, and so on may be verified.

FIG. 30 illustrates a structure of a transaction identification file(Transaction Handle) used when content library migration is performed according to an embodiment of the present invention.

A transaction identification file according to the present invention may include at least one of a transaction handle field, title field, transaction ID field, and migration count field.

Here, the migration count field represents the number of migration. Also, the transaction handle field represents transaction information(transaction handle) of 16 bytes, the title field represents title information, and the transaction ID field represents the ID of an established transaction.

In this case, the transaction handle field may be an essential element while others may be optional, but the present invention is not limited to this particular setting.

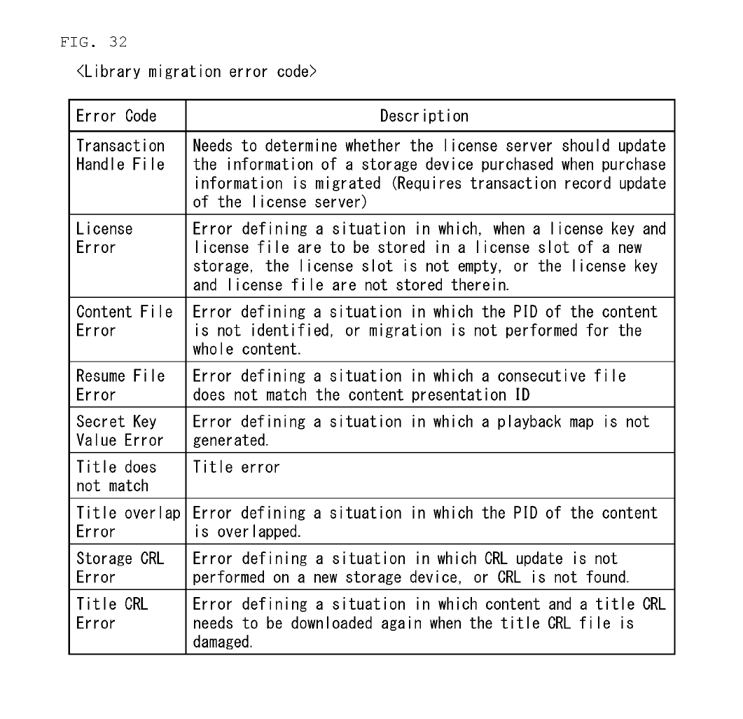

FIG. 31 is a block diagram illustrating a method for performing content library migration when a storage device is lost according to an embodiment of the present invention.

Referring to FIG. 31, storage device 1 is lost (or broken), and content is downloaded again to a new storage device 2.

First, storage device 2 may request certification for the contents purchased through a retailer S3110.

The retailer may register in the license server information about the storage device 2 and content purchase history S3120.

And after checking the migration field of the transaction identification file of the corresponding contents from the license server, the storage device 2 may be given a right for downloading contents S3130.

Here, the retailer may store storage device information, matching information between the user and the storage device, contents that the use has purchased, content transaction identification file, or information about whether the transaction is migration.

FIG. 32 is a table illustrating error codes defined when content library migration is performed according to an embodiment of the present invention.

The present invention may define library migration error codes.

For example, it may be needed to determine whether the license server should perform updating information of a storage device purchased at the time of migration of purchase information through the transaction identification file error. In this case, a transaction record of the license server needs to be updated.

A license error may represents a situation in which, when a license key and license file are to be stored in a license slot of a new storage, the license slot is not empty, or the license key and license file are not stored therein.

A content file error represents a situation in which the PID of the content is not identified, or migration is not performed for the whole content.

A consecutive file error represents a situation in which a consecutive file does not coincide with the PID.

A secret key value error represents a situation in which a playback map is not generated.

A “Title does not match” error represents a situation in which an error occurs in the title.

A title overlap error represents a situation in which the PID of the content is overlapped.

A storage CRL error represents a situation in which CRL update is not performed on a new storage device, or CRL is not found.

A title CRL error represents a situation in which content and a title CRL needs to be downloaded again when the title CRL file is damaged.

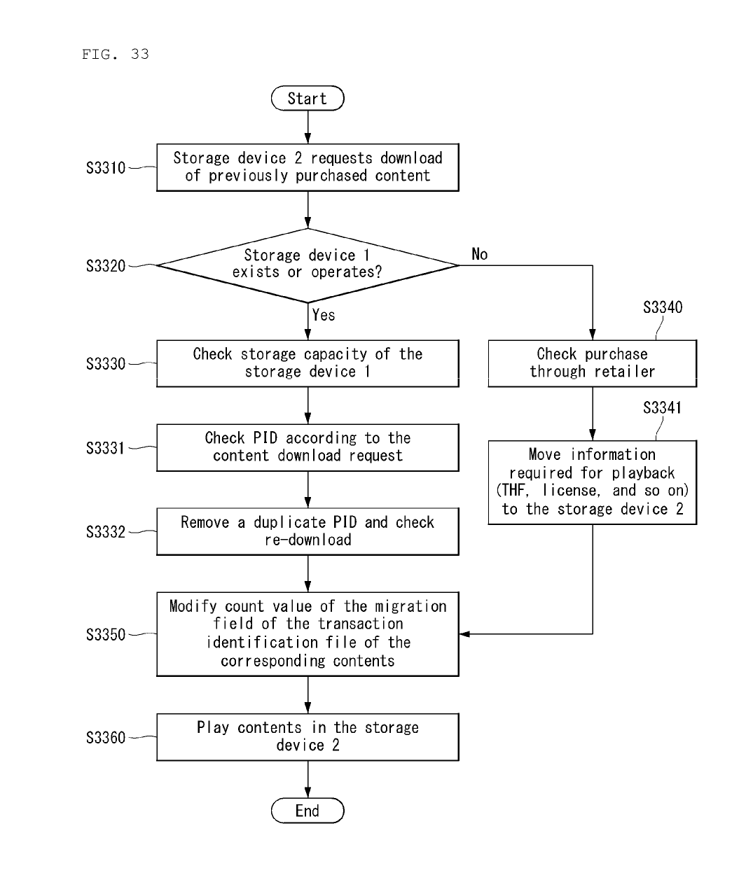

FIG. 33 is a flow diagram illustrating a method for performing content library migration on secure HD content according to an embodiment of the present invention.

FIG. 33 illustrates a situation in which storage device 2 attempts to download the previously purchased contents and storage device 1 already exists; and a situation in which the storage device 1 is lost or broken.

First, the storage device 2 may request downloading of the contents previously purchased S3310.

The storage device 2 may check existence of the storage device 1 S3320.

In the absence of the storage device 1, the storage device 2 may check purchase of the contents through the retailer S3340. And information required for playback may be moved to the storage device 2 S3341. Here, the information required for playback may include at least one of a transaction identification file and license file.

Afterwards, the count value of the migration field of the transaction identification file of the corresponding contents may be modified S3350.

And the storage device 2 may play the previously purchased contents S3360.

Meanwhile, when the storage device 1 exists according to the checking result in the S3320 step, the storage capacity of the storage device 2 may be checked S3330. And the PID may be checked according to the content download request S3331, a duplicate PID may be removed, and downloading may be performed again S3332.

Afterwards, after modifying the count value of the migration field of the transaction identification file of the corresponding contents S3350, the storage device 2 may play the previously purchased contents S3360.

In another embodiment of the present invention, connection unbinding may be performed after library migration.

The unbinding from an existing right may be deactivated without the transaction identification file.

For example, the license server may control binding/unbinding to and from the corresponding transaction number and the license through a transaction record.

Also, the license server may control so that library migration be performed only among the devices belonging to a specific area of a home network.

### INDUSTRIAL APPLICABILITY

Preferred embodiments of the present invention has been described for the purpose of illustration, and it should be understood by those skilled in the art that various other embodiments may be made by modifying or changing the present embodiments or applying substitution or addition of elements to the present embodiments within the technical principles and technical scope of the present invention disclosed in the appended claims.

1. A method for playing content stored in a storage device connected through at least one interface, comprising:
transmitting transaction information stored in a detected storage device to a license server, wherein the transaction information includes a transaction identification file for identifying at least one of corresponding transaction, seller, and user;
receiving license information allowing playback of the content from the license server; and
playing the content based on the license information,
wherein the license information includes a license file and a license key.

2. The method of claim 1, further comprising:
requesting loan permission of the content from a license server; and
receiving a response with respect to the request from the license server.

3. The method of claim 2,
wherein at least one of the transaction identification file or the license file includes a right information field indicating license type, and the license type is used for checking whether the license for the content is the original license or a loan license.

4. The method of claim 3,
wherein the transaction identification file further comprises loan version information.

5. The method of claim 3,
wherein the license file includes at least one of content loan time information, content return time information, encryption key for loan or return, and loan version information.

6. The method of claim 1, when the user performs migration of the content to another storage device, the method further comprising:
checking through the license server whether the user has a right for migration of the content; and
migrating the content to the another storage device when there exists a right for migration of the content according to the checking result.

7. The method of claim 6,
wherein the transaction identification file includes a migration count field, and the migration count field represents the number of migrations performed.

8. The method of claim 1,
wherein the content includes contents corresponding to multiple versions, and the multiple versions represent an image quality, and
wherein each of the contents corresponding to multiple versions corresponds to right information, and the right information allows the storage device to obtain the license information.

9. The method of claim 8,
wherein when the content is copied or moved to an unlicensed storage device by a user, only data file of the content is transmitted and new license information is required to play the content.

10. The method of claim 1, further comprising:
checking whether a right to copy or move the content is present through a server when the content is copied or moved to other storage device by a user; and
copying or moving the content to the other storage device when there exists the right to copy or move the content according to a result of the checking.

11. A device for playing content stored in a storage device connected through at least one interface, comprising:
an interface unit configured to detect connection of the storage device;
a controller configured to transmit transaction information stored in the detected storage device to a license server, receive license information allowing playback of the content from the license server, and play the content on the basis of the license information; and
a display unit configured to display the played content,
wherein the transaction information includes a transaction identification file for identifying at least one of corresponding transaction, seller, and user, and
wherein the license information includes a license file and a license key.

12. The device of claim 11,
wherein the controller is configured
to request loan permission of the content from a license server, and
to receive a response with respect to the request from the license server.

13. The device of claim 12,
wherein at least one of the transaction identification file or the license file includes a right information field indicating license type, and
wherein the license type is used for checking whether the license for the content is the original license or a loan license.

14. The device of claim 13,
wherein the transaction identification file further comprises loan version information.

15. The device of claim 13,
wherein the license file includes at least one of content loan time information, content return time information, encryption key for loan or return, and loan version information.

16. The device of claim 11, when the user performs migration of the content to a another storage device,
wherein the controller is configured
to check through the license server whether there exists a right for migration of the content, and
to migrate the content to the another storage device when there exists a right for migration of the content according to the checking result.

17. The device of claim 16,
wherein the transaction identification file includes a migration count field, and the migration count field represents the number of migrations performed.

18. The device of claim 11,
wherein the content includes contents corresponding to multiple versions, and the multiple versions represent an image quality, and
wherein each of the contents corresponding to multiple versions corresponds to right information, and the right information allows the storage device to obtain the license information.

19. The device of claim 18,
wherein when the content is copied or moved to an unlicensed storage device by a user, only data file of the content is transmitted and new license information is required to play the content.

20. The device of claim 11, further comprising:
a certification unit configured to check whether there exists a right to copy or move the content through a server when the content is copied or moved to another storage device by a user; and
the controller configured to copy or move the content to the another storage device when there exists the right to copy or move the content according to a result of the checking.
